(19) United States
(12) Patent Application Publication
(10) Pub. No.: US 2026/0210016 A1
(43) Pub. Date: Jul. 23, 2026

(54) METHOD FOR CONTROLLING CLOTHES TREATMENT APPARATUS

(71) Applicant: LG Electronics Inc., Seoul (KR)

(72) Inventor: Suncheol BAE, Seoul (KR)

(21) Appl. No.: 19/113,259

(22) PCT Filed: Sep. 26, 2023
(86) PCT No.: PCT/KR2023/014809

§ 371 Date: Mar. 19, 2025

(30) Foreign Application Priority Data
Sep. 26, 2022 (KR) 10-2022-0121553

(51) Int. Cl. D06F 34/30; D06F 29/02; D06F 34/18; D06F 101/14; D06F 101/20; D06F 103/04; D06F 103/38; D06F 105/52; D06F 105/58; H05B 47/105

(52) U.S. Cl. CPC D06F 34/30; D06F 29/02; D06F 34/18; H05B 47/105; D06F 2101/14; D06F 2101/20; D06F 2103/04; D06F 2103/38; D06F 2105/52; D06F 2105/58

(57) ABSTRACT

The present invention relates to a method for controlling a clothes treatment apparatus comprising: a drum for accommodating clothes; a driving unit for rotating the drum; a course selection unit for receiving an input of selecting one of random courses in which the driving unit is rotated to remove foreign substances from the clothes; and a plurality of option selection units for receiving an input of selecting one of random options for setting or changing conditions under which the course is performed, the method comprising: a timed washing input step of receiving a timed washing course, which is a course enabling a user to set the performance time of the course or option through the course selection unit; and a time adjustment step of enabling the performance time of the timed washing course to be changed, wherein, in the time adjustment step, when the timed washing input step is performed, the course selection unit and/or the option selection unit is switched to receive a command for adjusting the performance time of the timed washing course.

### TECHNICAL FIELD

The present disclosure relates to a method for controlling a laundry treating apparatus. More specifically, the present disclosure relates to a method for controlling a laundry treating apparatus that may adjust a time-definable washing execution time.

### BACKGROUND

In general, a laundry treating apparatus refers to an apparatus that may perform washing, drying, or washing or drying of laundry. In this regard, the laundry treating apparatus may perform only the washing or drying function, or may perform both the washing and the drying.

The existing laundry treating apparatuses operate for a set amount of time depending on an amount of laundry, so that users are not able to use the apparatuses for as long as they want, making it difficult to manage schedules thereof.

Accordingly, a laundry treating apparatus that may perform a time-definable washing course in which the user may specify an execution time initially guided has been provided.

Therefore, convenience has been maximized as the user is able to specify a washing time based on the schedule thereof.

However, although the execution time of the time-definable washing course may vary depending on the amount of laundry, because it is not able to know how much washing time is needed for a specific amount of laundry, the laundry treating apparatus has to be operated multiple times.

In addition, in a laundry treating apparatus equipped with an LED control panel, the user is not able to implement the time-definable washing course without a change of the existing control panel and is not able to adjust time because the time-definable washing course is not compatible with an existing input unit of the laundry treating apparatus.

Equipping a separate button for performing the time-definable washing course on the existing control panel of the laundry treating apparatus to solve the above problems damages aesthetics.

In addition, when changing the execution time of the time-definable washing course with an existing button, because there is no button to decrease the time, as the button is pressed, the time increases to a maximum, then is reset to a minimum, and then increases again, which is inconvenient when adjusting the time.

### SUMMARY

### Technical Problem

The present disclosure is to provide a laundry treating apparatus that may adjust an execution time of a time-definable washing course based on an amount of laundry.

The present disclosure is to provide a laundry treating apparatus that may adjust an execution time of a time-definable washing course by utilizing an existing control panel of the laundry treating apparatus.

The present disclosure is to provide a laundry treating apparatus that may increase as well as decrease a time of a time-definable washing course by utilizing an existing control panel of the laundry treating apparatus.

The present disclosure is to provide a laundry treating apparatus that may adjust an execution time within an upper or lower limit of the time-definable washing course execution time.

The present disclosure is to provide a laundry treating apparatus that may change an execution time of one or more of a washing cycle, a rinsing cycle, and a dehydration cycle when a user changes an execution time of a time-definable washing course.

The present disclosure is to provide a laundry treating apparatus that may maintain a washing effect even when a user changes an execution time of a time-definable washing course.

The present disclosure is to provide a laundry treating apparatus that may maintain a dehydration effect even when a user changes an execution time of a time-definable washing course.

### Technical Solutions

To solve the above-mentioned problems, provided is a laundry treating apparatus including a drum that accommodates laundry therein, a driver that rotates the drum, a course selector that receives an input of selecting one of arbitrary courses for removing foreign substances from the laundry by rotating the driver, and a plurality of option selectors that receive an input of selecting one of arbitrary options for setting or changing a condition for performing the course.

A method for controlling the laundry treating apparatus includes a time-definable washing input step of receiving input of a time-definable washing course that is a course where a user is able to specify an execution time of the course or the option via the course selector, and a time adjustment step of changing an execution time of the time-definable washing course,

The time adjustment step includes switching at least one of the course selector and the option selector to receive a command for adjusting the execution time of the time-definable washing course when the time-definable washing input step is performed.

The option selector may include a first option selector that selects one of options for setting conditions including an intensity and a number of times of the course, and a second option selector that receives an input for selecting an option different from the option of the first option selector.

The time adjustment step may include switching the first option selector to receive a command for increasing the execution time of the time-definable washing course when the first option selector is pressed, and switching the second option selector to receive a command for decreasing the execution time of the time-definable washing course when the second option selector is pressed.

The first option selector may be equipped as a reservation manager that determines an operating time of the laundry treating apparatus in advance, and the second option selector may be equipped as another component of the option selector disposed parallel to the reservation manager.

The option selector may be equipped as a separately pressable physical button.

The laundry treating apparatus may further include a plurality of lamps that illuminate corresponding to the option selector so as to induce pressing of the option selector.

When the time-definable washing input step is performed, at least one of the lamps may be illuminated to induce pressing of the option selector corresponding to the illuminated lamp.

The laundry treating apparatus may further include a display that displays information of the course or the option, and the method may further include a time-definable washing information display step of displaying an initial execution time of the time-definable washing course on the display when the time-definable washing input step is performed.

The method may further include a laundry amount sensing step of sensing an amount of laundry by rotating the drum, and the initial execution time of the time-definable washing course may vary depending on the amount of laundry sensed in the laundry amount sensing step.

The laundry treating apparatus may further include a display that displays information of the course or the option, and the time adjustment step may include displaying the changed execution time of the time-definable washing course on the display.

The display may include a time display that displays the execution time of the course or the option, and an initial execution time or the execution time changed in the time adjustment step of the time-definable washing course may be displayed on the time display.

The course selector may include a separate physical button for inputting the time-definable washing course.

The display may include a content display that displays the execution time of the course or the option, and an initial execution time or the execution time changed in the time adjustment step of the time-definable washing course may be displayed on the content display.

The time adjustment step may include illuminating two of the plurality of lamps.

The time adjustment step may include switching the first option selector to receive a command for increasing the execution time of the time-definable washing course when the first option selector is pressed, and switching the second option selector to receive a command for decreasing the execution time of the time-definable washing course when the second option selector is pressed, and among the plurality of lamps, a lamp corresponding to the first option selector and a lamp corresponding to the second option selector may be illuminated.

### Advantageous Effects

The present disclosure may adjust the execution time of the time-definable washing course based on the amount of laundry.

The present disclosure may adjust the execution time of the time-definable washing course by utilizing the existing control panel of the laundry treating apparatus.

The present disclosure may increase as well as decrease the time of the time-definable washing course by utilizing the existing control panel of the laundry treating apparatus.

The present disclosure may adjust the execution time within the upper or lower limit of the time-definable washing course execution time.

The present disclosure may change the execution time of one or more of the washing cycle, the rinsing cycle, and the dehydration cycle when the user changes the execution time of the time-definable washing course.

The present disclosure may maintain the washing effect even when the user changes the execution time of the time-definable washing course.

The present disclosure may maintain the dehydration effect even when the user changes the execution time of the time-definable washing course.

### BRIEF DESCRIPTION OF THE DRAWINGS

FIG. 1 shows an outer appearance of a laundry treating apparatus of the present disclosure.

FIG. 2 shows an internal structure of a laundry treating apparatus of the present disclosure when it is equipped as a washing machine.

FIG. 3 shows an internal structure of a laundry treating apparatus of the present disclosure when it is equipped as a drying machine.

FIG. 4 shows an internal structure of a laundry treating apparatus of the present disclosure when it is equipped as a composite apparatus equipped with the washing machine 10 and the drying machine 20.

FIG. 5 shows a structure of the control panel P of a laundry treating apparatus of the present disclosure.

FIG. 6 shows an embodiment of the first control panel P distinguished to be the interface I.

FIG. 7 shows an embodiment of the second control panel P2 distinguished to be the interface I.

FIG. 8 shows an embodiment of the third control panel P distinguished to be the interface I.

FIG. 9 shows a laundry amount sensing method of a laundry treating apparatus of the present disclosure.

FIG. 10 shows a laundry amount sensing calculation scheme of a laundry treating apparatus of the present disclosure.

FIG. 11 shows a basic structure in which the controller P may measure the current value of the driver 32 in the laundry treating apparatus of the present disclosure.

FIG. 12 shows an embodiment in which the controller P senses an amount of laundry via acceleration and deceleration of a drum.

FIG. 13 shows an embodiment of a laundry treating apparatus of the present disclosure utilizing a laundry amount sensing scheme.

FIG. 14 shows a control method for adjusting an execution time of a time-definable washing course of a laundry treating apparatus of the present disclosure.

FIGS. 15 to 18 sequentially show manipulation processes of a control panel P3 of a laundry treating apparatus of the present disclosure when adjusting an execution time of a time-definable washing course.

### BEST MODE

Hereinafter, embodiments disclosed herein will be described in detail with reference to the attached drawings. In the present document, identical or similar components are assigned identical or similar reference numerals even in different embodiments, and descriptions thereof are replaced with the first description. A singular expression used herein includes a plural expression unless the context clearly indicates otherwise. In addition, when describing the embodiments disclosed herein, when it is determined that a detailed description of a related known technology may obscure the gist of the embodiments disclosed herein, the detailed description thereof will be omitted. In addition, it should be noted that the attached drawings are only intended to facilitate easy understanding of the embodiments disclosed herein, and the technical ideas disclosed herein should not be construed as being limited by the attached drawings.

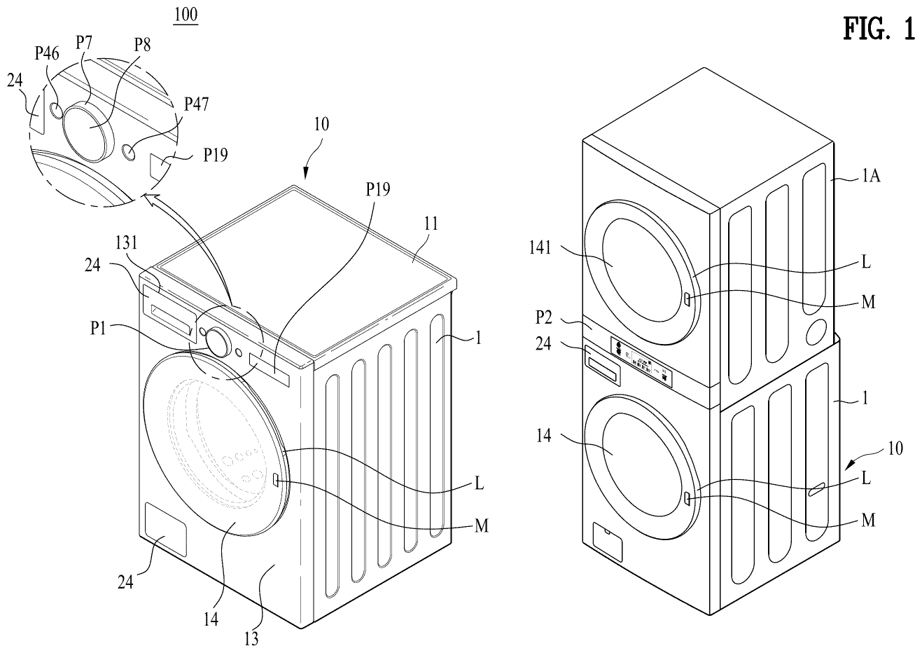

FIG. 1 shows an outer appearance of a laundry treating apparatus 100 of the present disclosure.

The laundry treating apparatus 100 of the present disclosure may be equipped with one washing machine 10 or drying machine 20, may be equipped with a plurality of washing machines 10 or a plurality of drying machines 20 stacked or arranged inside a single cabinet, or may be equipped with the washing machine 10 and the drying machine 20 stacked or arranged inside the single cabinet.

As a result, the laundry treating apparatus of the present disclosure may be equipped with any shape and any form as long as it is able to treat laundry.

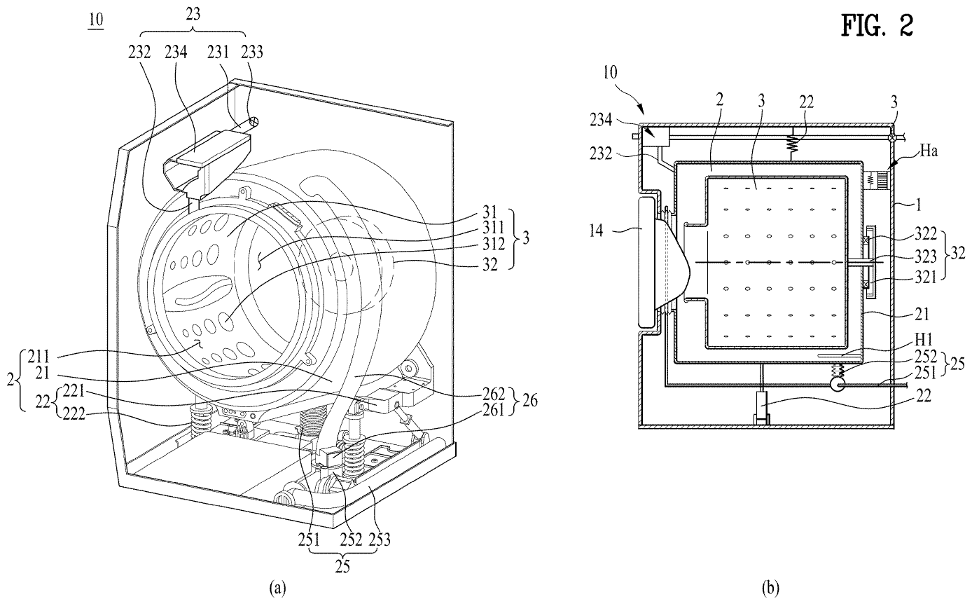

(a) in FIG. 1 shows an embodiment in which the laundry treating apparatus 100 of the present disclosure is equipped with the washing machine 10 that removes foreign substances from the laundry or the drying machine 20 that dries the laundry, and (b) in FIG. 2 shows an embodiment in which the laundry treating apparatus 100 of the present disclosure is equipped with the washing machine 10 that removes the foreign substances from the laundry and the drying machine 20 that removes moisture from the laundry together.

The laundry treating apparatus of the present disclosure may include a first control panel P1 that provides an algorithm for performing one of a washing cycle of removing the foreign substances from the laundry with water and detergent, a rinsing cycle of removing the foreign substances from the laundry and the detergent, a dehydration cycle of removing water from the laundry using a centrifugal force or the like, a drying cycle of removing moisture from the laundry using at least one of air and steam, and a refreshing cycle of performing at least one of deodorization, wrinkle removal, and sterilization of the laundry using at least one of air and steam.

The first control panel P1 may include a device that enables communication between a user and the laundry treating apparatus (including other electronic devices including the laundry treating apparatus).

The communication between the user and the laundry treating apparatus may include a process in which the user inputs various control commands to the laundry treating apparatus, and a process in which the laundry treating apparatus transmits a response (feedback) to the control commands or information generated from the laundry treating apparatus to the user.

Referring to (a) in FIG. 1, the laundry treating apparatus 100 of the present disclosure may include a cabinet 1 forming the outer appearance.

The first control panel P1 of the laundry treating apparatus of the present disclosure may include the first control panel P1 equipped on the cabinet 1 and capable of controlling one washing machine 10 or one drying machine 20.

The first control panel P1 may be equipped to receive at least one of a power command of supplying or cutting off power to the laundry treating apparatus, a selection command of selecting an arbitrary course or option to treat the laundry, an execution command of executing the selected course or option, and a stop command of stopping the course or option being executed.

The treatment of the laundry may include the washing cycle of removing the foreign substances from the laundry using water and the detergent, the drying cycle of drying water contained in the laundry, and the refreshing cycle of performing the deodorization and the wrinkle removal of the laundry using hot air and steam.

The first control panel P1 may include a screen P8 that displays an operating state of the laundry treating apparatus or information on the course or the option to the user.

The screen P8 may display a state in which at least one of the power command, the selection command, the execution command, and the stop command has been input.

In addition, the screen P8 may display error information indicating a problem situation that has occurred in the laundry treating apparatus or guidance information guiding the user on what actions to take.

The screen P8 may visually display the information. The screen P8 may include a liquid crystal display that radiates light to the outside.

In one example, the first control panel P1 may include at least one of speakers capable of outputting voice signals and sounds.

In the laundry treating apparatus 100 of the present disclosure, the cabinet 1 may include a front panel 13 forming a front side, and a top panel 11 coupled to an upper side of the front panel 13. The front panel 13 and the top panel 11 may be made of a metal material and may be formed in a steel plate shape.

The first control panel P1 of the laundry treating apparatus of the present disclosure may be coupled to the front panel 13.

The first control panel P1 may not be formed as a separate support panel and disposed on the front panel 13, but may be directly coupled to a rear surface of the front panel 13. The first control panel P1 may be exposed only partially to a front surface of the front panel 13.

As a result, a ratio of an area occupied by the first control panel P1 in the front panel 13 may be minimized, and a sense of unity of the front panel 13 may be strengthened, so that aesthetics may be maximized.

In addition, a process of manufacturing the front panel 13 may be simplified, and a process of assembling or installing the front panel 13 and the first control panel P1 may be simplified. In addition, a separate frame or the like for seating the first control panel P1 on the front panel 13 may be omitted.

The first control panel P1 of the laundry treating apparatus of the present disclosure may include not only the screen P8 but also a rotary knob P7 that may receive a command for selecting the course or the like from the user.

The rotary knob P7 may be formed in a form of the rotary knob, and the screen P8 may be formed as a display D including a liquid crystal display device or the like. It may be seen that the screen P8 and a selector R to be described below are included inside the rotary knob P7.

The screen P8 may be formed entirely as a touch panel, or at least partially as the touch panel. In one example, the screen P8 may be equipped as a simple liquid crystal display so as not to receive separate commands and to only display information.

The rotary knob P7 may be equipped to rotate on the front panel 13 such that an arbitrary course or option that may treat the laundry may be selected.

The screen P8 may be equipped to display a corresponding course or option each time the rotary knob P7 rotates.

Accordingly, the laundry treating apparatus of the present disclosure may omit description of the arbitrary course or option that may rotate a drum to be described below in a form of text, guidance text, and the like on the front panel 13. Accordingly, the area size or the ratio of the area size that the first control panel P1 occupies on the front panel 13 may be significantly reduced, and because no separate text or guidance text is attached to the front panel 13, the aesthetics may be maximized.

In addition, even when the laundry treating apparatus of the present disclosure is sold to various countries with different languages, the front panel 13 or the first control panel P1 may be prevented from being produced differently.

The rotary knob P7 and the screen P8 may operate only when power is supplied thereto. To this end, the first control panel P1 of the laundry treating apparatus of the present disclosure may further include a power button P46 for inputting the power command to the laundry treating apparatus in addition to the rotary knob P7 and the display.

The user may activate the rotary knob P7 by pressing the power button P46.

In addition, the first control panel P1 may further include an execution button P47 for inputting the execution command to execute or stop the selected course or option. The execution button P47 may be formed separately from the rotary knob P7 and the screen P8 so as to receive a user's definite intent to execute or stop.

The power button P46 and the execution button P47 may be formed separately from the rotary knob P7 to prevent the functions of the rotary knob P7 and the screen P8 from being excessive.

In one example, the first control panel P1 may further include a setting area P19 that may add or change options to the course on the front panel 13. The user may set options that may change the intensity, a duration, and the like of the course via the setting area P19.

The setting area P19 may include a liquid crystal display device separate from the screen P8. The setting area P19 may include a touch panel or a physical button that may input the options.

The first control panel P1 may be equipped to be in communication with a controller that may operate the laundry treating apparatus, or may have the controller installed thereon. The controller may be formed in a shape of a PCB installed on the control panel P.

In one example, the front panel 13 may include an inlet 111 that is in communication with the drum accommodated in the cabinet 1, and a door 14 that is pivotably coupled to the cabinet and opens and closes the inlet 111.

The first control panel P1 may be positioned above the door 14 to enhance user accessibility.

In one example, the front panel 13 may further include a lock L that fixes the door 14 to the front panel 13. When the laundry treating apparatus is operated, such as when the drum of the laundry treating apparatus rotates, the lock L may lock the door 14 to the front panel 13. This may prevent a safety accident. The lock L may unlock the door 14 when the laundry treating apparatus is finished operating.

The lock L may be equipped as any component as long as it may fix the door 14 to the cabinet 1. The lock L may be equipped as a fastener that secures a hook protruding from the door, and may also be equipped as a solenoid valve that holds the hook.

The laundry treating apparatus of the present disclosure may include a detergent box 24 that accommodates therein the detergent for washing the laundry, and the front panel 13 may include a detergent hole 131 from which the detergent box 243 is extended.

The front panel 13 may include a filter hole 24 through which a filter of the laundry treating apparatus may be replaced.

Referring to (b) in FIG. 1, in the laundry treating apparatus of the present disclosure, the washing machine 10 and the drying machine 20 may be stacked.

The washing machine 10 may be equipped with a washing cabinet 1, and the drying machine 20 may include a drying cabinet 1A that may be seated or supported on the washing cabinet 1.

In addition, the washing machine 10 and the drying machine 20 may share one cabinet 1.

The control panel P of the laundry treating apparatus of the present disclosure may include a second control panel P2 that may simultaneously control the washing machine 10 and the drying machine 20. As a result, the washing machine 10 and the drying machine 20 may share the second control panel P2. As a result, inconvenience of controlling the washing machine 10 and the drying machine 20 with the separate control panels P or installing the plurality of control panels P may be prevented.

The second control panel P2 may receive a user's command via user's touch or the like without a separate physical button.

The second control panel P2 may include a power area P25 that receives a command to supply the power to the washing machine 10 and the drying machine 20, a control area P22 that displays display states of the washing machine 10 and the drying machine 20, and an execution area P26 that receives a command to operate the washing machine 10 and the drying machine 20.

In addition, in second control panel P2, the control area P22 may be equipped as a touch panel that receives a command to select an arbitrary course for operating the washing machine 10 and the drying machine 20 or a command to select an option for adjusting a function or an intensity related to the course.

As a result, the control area P22 may be equipped to not only display information necessary for the user, but also receive a necessary control command via the user's touch.

The control area P22 may display only one of information of the washing machine 10 and the drying machine 20, and transmit the user's input to only one of the washing machine 10 and the drying machine 20.

To this end, the second control panel P2 may further include a switching area P27 that switches a subject displayed on the control area P22 of the washing machine 10 and the drying machine 20, or switches the information input to the control area P22 to be transmitted to one of the washing machine 10 and the drying machine 20.

FIG. 2 shows an internal structure of a laundry treating apparatus of the present disclosure when it is equipped as the washing machine 10.

(a) in FIG. 2 is a perspective view of the washing machine 10 of the present disclosure, and (b) in FIG. 2 is a cross-sectional view of the washing machine 10 of the present disclosure.

The washing machine 10 of the present disclosure may include the cabinet 1 that forms the outer appearance, a tub 2 accommodated in the cabinet 1 to store water, a drum 3 rotatably disposed in the tub 2 to store water, a driver 32 coupled to the tub 2 to rotate the drum 3, a water supply 23 that supplies water to the tub 2, and a drainage 25 that drains water from the tub 2.

The driver 32 may include a stator 321 coupled to a rear side of the tub 2, a rotor 322 rotated by the stator 321, and a rotation shaft 323 coupled to the rotor 322 to rotate the drum 3.

The water supply 23 may include a water supply pipe 231 that allows an external water source and the tub 2 to be in communication with each other, and a water supply valve 233 that opens and closes the water supply pipe 231.

In one example, the water supply 23 may further include a detergent box 234 that may be extended forward of the cabinet 1 to allow the detergent to be injected into the tub 2, the water supply pipe 231 may be in communication with the detergent box 234, and the detergent box 234 may be connected to the tub 2 via a supply pipe 232.

The drainage 25 may include a drainage pipe 251 disposed under the tub 2, a drainage pump 252 that is coupled to the drainage pipe 251 and provides power to discharge water, and a discharge pipe 253 that discharges water from the drainage pump 252 to the outside.

The laundry treating apparatus 100 of the present disclosure may further include a support 22 that supports the tub 2 and the drum 3 to the cabinet 1.

The support 22 may include a damper 222 or a spring that supports the tub 2, and a bearing housing module 221 that supports loads of the drum 3 and the driver 32.

The laundry treating apparatus 100 of the present disclosure may further include a circulator 26 that circulates water discharged to the drainage 25 back to the tub 2. The circulator 26 may include a circulation pump 261 that is in communication with the drainage pipe 251, and a circulation pipe 262 that supplies water from the circulation pump 261 to an upper portion of the tub 2. The circulation pump 261 and the drainage pump 252 may be formed integrally.

The laundry treating apparatus of the present disclosure may include a hot air supply Ha that may separately supply hot air to the tub 2. The hot air may be utilized to dry the laundry.

In addition, the laundry treating apparatus of the present disclosure may include a heater H1 that heats water contained in the tub 2.

The heater H1 may be disposed between a bottom surface of the tub and a bottom surface of the drum to prevent water from being exposed to air inside the tub even when a small amount of water is supplied and to also heat the small amount of water.

Accordingly, the washing machine 10 of the present disclosure may receive a command from the first control panel P1 and operate at least one of the driver 32, the water supply valve 233, and the drain pump 252 to perform the arbitrary washing course and washing option for removing the foreign substances from the laundry. The washing course and the washing option may be composed of a series of control methods that may perform all of the washing cycle, the rinsing cycle, and the dehydration cycle.

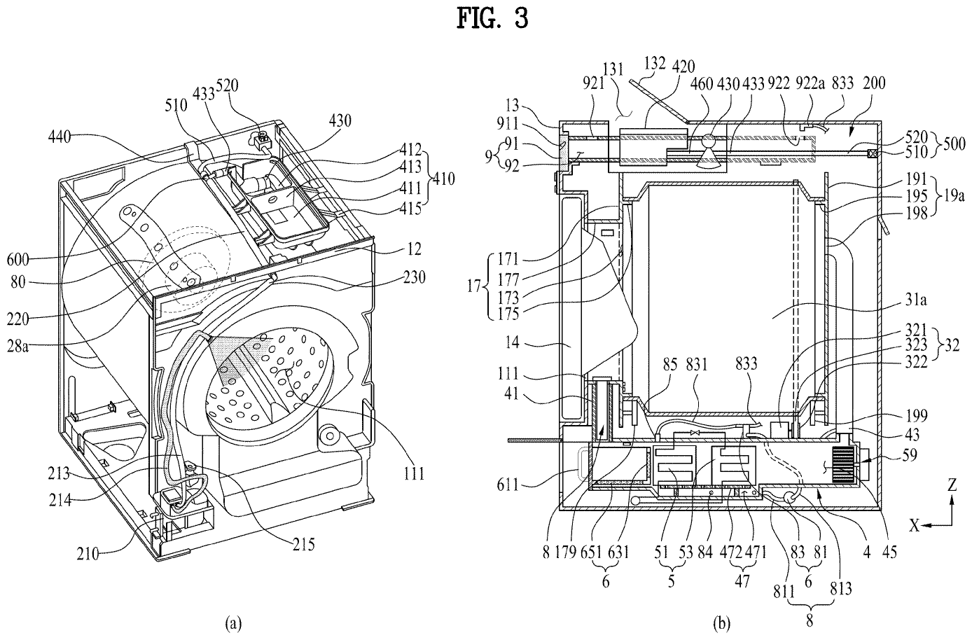

FIG. 3 shows an internal structure of a laundry treating apparatus of the present disclosure when it is equipped as the drying machine 20.

(a) in FIG. 3 is a perspective view of the drying machine 20 of the present disclosure, and

(b) in FIG. 3 is a cross-sectional view of the drying machine 20 of the present disclosure.

The drying machine 20 of the present disclosure may include the drying cabinet 1A, a drum 3A rotatably disposed inside the cabinet to provide a space for storing the laundry, a circulation flow channel 4 that forms a flow channel for re-supplying air discharged from the drum 3A to the drum 3A, and a heat exchanger 5 that dehumidifies and heats air introduced into the circulation flow channel 4 and then re-supplies air to the drum 3A.

The drum 3A may be referred to as a drying drum 3A hereinafter to be distinguished from the drum 3 of the washing machine described above.

A drying sensor that senses dryness of the laundry may be disposed in the drying drum 3A or the cabinet 1A.

When the drying drum 3A is equipped with a cylindrical drum body 31 in which a front surface and a rear surface are open, a first support 17 that rotatably supports the front surface of the drying drum 3A and a second support 19 that rotatably supports the rear surface of the drying drum 3A may be disposed inside the cabinet 1A.

The first support 17 may include a first fixed body 171 fixed inside the cabinet 1, a drum inlet 173 that extends through the first fixed body and allows the inlet 111 and the inside of the drum body 31 to be in communication with each other, and a first support body 175 that is disposed in the first fixed body 171 and inserted into the front surface (a first open surface) of the drum body 31.

The first fixed body 171 may be formed in any shape as long as the drum inlet 173 and the first support body 175 may be formed. The first support body 175 may be formed in a pipe shape protruding from the first fixed body 171 toward the drum body 31. A diameter of the first support body 175 may be set to be greater than a diameter of the drum inlet 173 and smaller than a diameter of the front surface of the drum body 31. In this case, the drum inlet 173 will be located within a space defined by the first support body 175.

The first support 17 may further include a connecting body 177 connecting the inlet 111 with the drum inlet. The connecting body 177 may be formed in a pipe shape extending from the drum inlet 173 toward the inlet 111. The connecting body 177 may include an air outlet 178 that is in communication with the circulation flow channel 4.

The air outlet 178 may be a passage that allows air inside the drum body 31 to flow to the circulation flow channel 4, and may be defined as a through-hole that extends through the connecting body 177.

The second support 19A may include a second fixed body 191 fixed inside the cabinet 1, and a second support body 195 that is disposed in the second fixed body 191 and inserted into the rear surface (a second open surface) of the drum body 31. The second support 19A includes an air inlet 198 that extends through the second fixed body 191 and allows the inside of the drum body 31 to be in communication with the inside of the drying cabinet 1A.

In this case, the circulation flow channel 4 may be equipped as a duct 4 through which air flows, and may connect the air outlet 178 with the air inlet 198.

The hollow cylindrical drum body 31 may be rotated by various types of drivers. A case in which a drying driver 32A includes a motor 321 fixed inside the cabinet 1A, a pulley 322 rotated by the motor, and a belt 323 connecting a circumferential surface of the pulley 232 with a circumferential surface of the drum body 31 is shown as an example.

In one example, the drying driver 32A may be disposed on a rear surface of the drying drum 3A to directly rotate the drying drum 3A. A rotation shaft of the drying driver 32A may be directly coupled to the drying drum 3A to rotate the drying drum 3A.

In this case, the second support 19A may support the drying driver 32A such that the drying driver 32A is located on the rear surface or a center of the drying drum 3A.

In one example, a separate reducer may be disposed between the driver and the drying drum 3A. In this case, a rotation shaft from the reducer may be directly coupled to the rear surface center of the drying drum 3A, and the reducer may be coupled to and supported by the second support 19A.

In such case, the drying driver 32A may freely change a rotation speed and a rotation direction of the drying drum 3A.

The first support 17 may be equipped with a first roller 179 that rotatably supports the circumferential surface of the drum body 31, and the second support 19A may be equipped with a second roller 199 that rotatably supports the circumferential surface of the drum body.

The circulation flow channel 4 may include the duct 4 that is in communication with the drying drum 3A.

The duct 4 may be in communication with the drying drum 3A, and may be viewed as forming a circulation flow channel in which air discharged from the drum passes through the heat exchanger 5 and is re-introduced into the drying drum 3A.

The duct 4 may include an exhaust duct 41 connected to the air outlet 178, a supply duct 43 connected to the air inlet 198, and a connecting duct 45 connecting the exhaust duct with the supply duct.

The heat exchanger 5 may be equipped as various apparatuses that may sequentially perform dehumidification and heating of air introduced into the duct 4. For example, the heat exchanger 5 may be equipped as a heat pump system.

The heat exchanger 5 may include a fan 59 that allows air to flow along the duct 4, a first heat exchanging apparatus (a heat absorber) 51 that removes moisture from air introduced into the duct 4, and a second heat exchanging apparatus (a heat generator) 53 that is disposed inside the duct 4 and heats air that has passed through the first heat exchanging apparatus 51.

The heat absorber 51 may be equipped as an evaporator that absorbs heat, and the heat generator 53 may be equipped as a condenser that releases heat.

The fan 59 may include an impeller 591 disposed inside the duct 4, and an impeller motor 593 that rotates the impeller 591.

The impeller 591 may be disposed in any of the exhaust duct 41, the connecting duct 45, and the supply duct 43. The impeller 591 may be disposed in the supply duct 43.

The heat absorber 51 may be equipped as multiple metal plates arranged along a width direction of the connecting duct 45 (a Y-axis direction) or a height direction of the connecting duct (a Z-axis direction), and the heat generator 53 may be equipped as multiple metal plates arranged along the width direction of the connecting duct or the height direction of the connecting duct. The heat absorber 51 and the heat generator 53 are sequentially arranged in a direction from the exhaust duct 41 to the supply duct 43 inside the connecting duct 45, and are connected to each other via a refrigerant pipe 58 forming a circulation flow channel of a refrigerant.

The refrigerant moves along the refrigerant pipe 58 by a compressor 55 located outside the duct 4, and the refrigerant pipe 58 includes a pressure regulator 57 that adjusts a pressure of the refrigerant that has passed through the heat generator 53.

The heat absorber 51 is a means for cooling air and evaporating the refrigerant by transferring heat of air introduced into the exhaust duct 41 to the refrigerant. The heat generator 53 is a means for heating air and condensing the refrigerant by transferring heat of the refrigerant that has passed through the compressor 55 to air. In this case, moisture contained in air will be collected on a bottom surface of the connecting duct 45 along a surface of the heat absorber 51 when passing through the heat absorber 51.

To collect water removed from air passing through the heat absorber 51, the laundry treating apparatus 100 includes a water collector.

Water collected in the water collector may be collected in a water storage 9 and

discharged in batches later. The water storage 9 may include a water storage tank 92 that is detachably disposed in the cabinet 1 and provides a space for storing water, and a water storage inlet 922 that extends through the water storage tank 92 and allows water discharged from a water storage supply pipe 633 to flow into the water storage tank 92.

The water storage tank 92 may be equipped as a drawer-type tank that is extended from the cabinet 1A. In this case, a front panel 13A of the cabinet should have a water storage mounting hole or a tank hole 131 into which the water storage tank 92 is inserted. A water storage panel 91 is fixed to a front surface of the water storage tank 92. The water storage panel 91 may be detachably coupled to the water storage mounting hole or the tank hole 115 to form a portion of the front panel 13A.

The water storage panel 91 may further include a groove 911 into which a user's hand is inserted. In this case, the water storage panel 91 will also perform a function of a handle for extending the water storage tank 92 from the cabinet or inserting the same into the cabinet.

The water storage inlet 922 may receive water discharged from a nozzle 823A fixed to the cabinet 1A. The nozzle 823A may be fixed to the top panel 11 of the cabinet so as to be positioned upward of the water storage inlet 922 when the storage body 92 is inserted into the cabinet 1.

The water storage 9 having the above-described structure allows the user to drain water inside the water storage tank 92 by flipping or tilting the water storage tank 92 in a direction toward the water storage inlet 922 after extending the water storage tank 92 from the cabinet 1. A communication hole 921 extending through a top surface of the water storage tank 92 may be further included such that water inside the water storage tank 92 may be easily discharged via the water storage inlet 922.

A steam unit 200 may be disposed to be spaced apart from the water storage 9. As described above, the steam unit 200 may be connected to an internal water supply 400 and an external water supply 500 to receive water and generate steam.

The external water supply 500 may include a direct water valve 520 adjacent to or fixed to a rear panel 13, and a direct water pipe 510 that supplies water delivered from the direct water valve 520 to the steam unit 200. The direct water valve 520 may be coupled with the external water source. For example, the direct water valve 520 may be coupled with a water supply pipe extending to a rear surface of the cabinet. As a result, the steam unit 200 may receive water directly via the direct water valve 520. Therefore, even when the internal water supply 400 is omitted or water is not stored in the internal water supply 400, the steam unit 200 may receive water via the direct water valve 520 whenever necessary. The direct water valve 520 may be directly controlled by a steam controller 800.

In one example, the steam unit 200 may be disposed adjacent to the direct water valve 520, but may be disposed close to the front panel 13. As a result, steam may be supplied to a front side of the drum and evenly supplied to the entire laundry.

The internal water supply 400 may include a water tank 420 that stores water, a water pump 430 that may supply water to the steam unit 200 by receiving water from the water tank 420, and a tank housing 410 that provides a space for seating the water tank 420 and the water pump 430. The water pump 430 and the water tank 420 may be disposed at a vertical level corresponding to the steam unit 200.

A tank withdrawal hole 131 may be installed in an area corresponding to a portion where the water tank 420 is installed in the top panel 11. As a result, the water pump 430 may be prevented from being unnecessarily exposed to the tank withdrawal hole 131 as much as possible.

A withdrawal cover 132 may be pivotably coupled to an outer peripheral surface of the tank withdrawal hole 131 to prevent the water tank 420 from being unnecessarily exposed to the outside.

The steam unit 200 may be in communication with the drying drum 3A or the circulation flow channel 4 and supply steam into the drying drum 3A. The steam unit 200 may receive water via a water supply 300, generate steam, and then supply steam to the drying drum 3A or the duct 4 via a steam discharge pipe 213.

The steam discharge pipe 213 may be in direct communication with the drying drum 3A to supply steam into the drying drum 3A, and may be in communication with the duct 4 or the second support 19 to indirectly supply steam into the drying drum 3A.

The steam discharge pipe 213 may be in communication with the supply duct 43 when being connected to the duct 4, and may be in communication with the water storage inlet 922 when being connected to the second support 19A. As a result, steam may be more smoothly supplied into the drying drum 3A using the power of the blower fan 59.

The steam unit 200 may be controlled to generate steam when a steam supply mode that uses steam is performed during the drying cycle. The steam supply mode may correspond to a series of drying courses of sterilizing the laundry, increasing a temperature inside the drum during the drying cycle of the laundry, or removing wrinkles from the laundry at an end of the drying cycle of the laundry.

The steam unit 200 may be controlled to supply steam into the drying drum 3A or the like by receiving water via the internal water supply 400 as well as the external water supply 500 as needed.

In one example, the heat exchanger 5 condenses moisture in air circulating in the heat absorber 51. Therefore, even when air circulates in the drying drum 3A, because moisture is removed in the heat absorber 51, the laundry inside the drying drum 3A may be continuously dried.

Moisture condensed in the heat absorber 51 may be primarily collected in the water collector 47 and then secondarily collected in the water storage 9. The water collector 47 may be located inside the connecting duct 45, and may be formed separately in a space separated from the connecting duct 45.

A rotation center of the drying drum 3A may be disposed between the steam unit 200 and the heat exchanger 5 based on a height direction of the cabinet. In addition, the heat exchanger 5 may be disposed downward of the rotation center of the drying drum 3A, and the steam unit 200 may be disposed upward of the rotation center of the drying drum, based on the height direction of the cabinet.

The water collector 47 may be equipped as a water collecting body 471A fixed to a bottom surface of the connecting duct 45 and in communication with the inside of the connecting duct.

To prevent the heat absorber 51 and the heat generator 53 from being in contact with water (condensed water) stored in the water collecting body 471A, a heat exchanging apparatus support 473A may be further disposed inside the water collecting body 471A.

The heat exchanging apparatus support 473A may be equipped as a support plate on which the heat absorber 51 and the heat generator 53 come into contact. The heat exchanging apparatus support 473A may further include a spacer 475 that maintains a spacing between the support plate and a bottom surface of the water collecting body 471A, and a support plate through-hole 476 that extends through the support plate.

The support plate through-hole 476 may be defined only in a space where the heat absorber 51 is supported in a space provided by the support plate, or may be defined in each of the space in which the heat absorber is supported and a space in which the heat generator is supported. When the support plate through-hole 476 is also defined in a lower portion of the heat generator 53, water that has flowed to the heat generator 53 along the support plate 373 may be discharged to the water collecting body 471.

To minimize foreign substances (lint or the like) discharged from the drum body 31 from accumulating on the heat absorber 51 and the heat generator 53, the laundry treating apparatus 100 may further include a filter that filters air.

A second filter 7 may be disposed as a means for filtering air introduced into the exhaust duct 41 from the drum body 31, and a first filter 6 may be disposed as a means that is located between the second filter 7 and the heat absorber 51 and filters air that has passed through the second filter 7. A diameter of a filter hole defined in the first filter 6 may be set smaller than a diameter of a filter hole defined in the second filter 7.

The first filter 6 may be detachably disposed in the connecting duct 45. In this case, a filter mounting hole through which the first filter 6 is withdrawn and a mounting hole door 14 for opening and closing the filter mounting hole may be disposed in the front panel 13 of the cabinet, and a duct through-hole 44 into which the first filter 6 is inserted may be defined in the duct 4.

Therefore, the user may remove the foreign substances remaining in the first filter 6 and wash the first filter after separating the first filter 6 from the laundry treating apparatus as needed.

In one example, the laundry treating apparatus 100 may further include a washer 8 that washes the first filter 6 using water stored in the water collecting body 471. That is, water stored in the water collecting body 471 may be collected separately into the water storage 9 or may selectively flow to the washer 8.

The washer 8 may be equipped as a means for washing the first filter 6 by spraying water stored in the water collecting body 471.

The washer 8 may include a spray 85 that is disposed in the duct 4 to supply water to the first filter 6, and a washing pump 81 that allows water stored in the water collection body 471 to flow to the spray 85.

The washing pump 81 may be connected to the water collection body 471 via a first connecting pipe 811 and may be connected to the spray 85 via a second connecting pipe 813.

When the laundry treating apparatus is constructed to allow water in the water collection body 471 to flow to the spray 85 and the water storage 9 with only one washing pump 81, the laundry treating apparatus 100 may further include a flow channel switcher 83.

In this case, the flow channel switcher 83 may be connected to the washing pump 81 via the second connecting pipe 813, the spray 85 may be connected to the flow channel switcher 83 via a spray supply pipe 831, and the water storage 9 may be connected to the flow channel switcher 83 via a water storage supply pipe 833.

The flow channel switcher 83 may include a valve that controls opening and closing of the spray supply pipe 831 and the water storage supply pipe 833. Accordingly, the laundry treating apparatus 100 may supply water stored in the water collecting body 471 to the spray 85 or to the water storage 9 by controlling the valve disposed in the flow channel switcher 83.

To determine a time point of stopping the operation of the heat exchanger 5 by determining the dryness of the laundry, the laundry treating apparatus 100 may be equipped with a dryness sensor.

The drying driver 32A may be directly fastened to the rear surface of the drying drum 3A. The drying driver 32A may be disposed on the second support 19A and directly rotate the drying drum 3A.

The drying driver 32A may include a stator supported by the second support 19, and a rotor and a rotation shaft that are rotated by the stator.

The drying driver 32A may be separately coupled to a reducer 28A, and the reducer 28A may be coupled to a center of a rear surface (a center of rotation) of the drying drum 3A to rotate the drying drum 3A. Accordingly, the reducer 28A may decrease an RPM of the rotation shaft while increasing a torque.

The steam unit 200 may be fixed to the front panel 13 or the first support 17 that supports the drying drum 3A for space utilization. In addition, the steam unit 200 may be disposed adjacent to a corner of the cabinet 1.

The internal water supply 400 may include the water tank 420 that stores water, the water pump 430 that provides the power to supply water stored in the water tank 420 to the steam unit 200, and the tank housing 410 that provides the space in which the water pump 430 and the water tank 420 are installed.

The tank housing 410 may be formed in a box shape with an open top, and may extend along a front and rear direction of the cabinet 1 such that the water pump 430 may be disposed in a front portion of the cabinet 1A and the water pump 430 may be disposed in a rear portion of the cabinet 1A.

The tank housing 410 may include a tank mounting portion 411 on which the water tank 420 is detachably seated, and a pump mounting portion 412 on which the water pump 430 may be mounted. The tank mounting portion 411 and the pump mounting portion 412 may be formed in a recessed shape to prevent water leaking from the water tank 420 or the water pump 430 from flowing out to the drum 2 or the like.

In addition, the tank housing 410 may further include a partition wall 413 that partitions the tank mounting portion 411 and the pump mounting portion 412 from each other. As a result, the water tank 420 may be easily mounted in and separated from the tank housing 410. The partition wall 413 may also perform a role of collecting residual water in the tank mounting portion 411 or in the pump mounting portion 412 such that residual water does not flow to another location.

An extension pipe 416 that allows the water tank 420 and the water pump 430 to be in communication with each other may be installed in the partition wall 413. A valve structure may be installed on the extension pipe 416, so that even when the water tank 420 is separated from the tank mounting portion 411, water leakage may be prevented.

The extension pipe 416 may extend from the partition wall 413 toward the water pump 430 or the water tank 420.

In one example, the tank housing 410 may be formed such that the pump mounting portion 412 is disposed closer to the steam unit 200 than the tank mounting portion 411. As a result, a flow channel supplied from the water tank 420 to the steam unit 200 may be simplified.

The tank housing 410 may be formed such that the tank mounting portion 411 and the pump mounting portion 412 are disposed along the front and rear direction of the cabinet.

The water supply 300 may include a joint that may fix the tank housing 410 to at least one of a support bar 440 and one side surface of the cabinet.

The components arranged inside the cabinet 1A need to be arranged to be spaced apart from the drying drum 3A. Therefore, the water supply 300 and the steam unit 200 need to be prevented from coming into contact with the drum 2. For example, a steam guide pipe 230 that supplies steam from the steam unit 200 to the drum 2, the direct water pipe 510 that supplies water to the steam unit 200, or the like needs to be blocked from coming into contact with the drum 2.

In one example, the water tank 420 and the water pump 430 as well as a load of water contained in the water tank 420 need to be supported.

Therefore, the laundry treating apparatus of the present disclosure may include the support bar 440 that supports the steam unit 200 and the water supply 300 to prevent the steam unit 200 and the water supply 300 from coming into contact with the drum, and supports the steam unit 200 and the water supply 300 inside the cabinet.

The support bar 440 may support at least a portion of the steam unit 200 or at least a portion of the water supply 300. In addition, the support bar 440 may fix or support the tank housing 410 to the cabinet.

The support bar 440 may be formed in a bar shape with both ends connected to the front panel 13 and the rear panel 12. Thus, the support bar 440 may not only support a load of the tank housing 410, but also fix the front panel 13 and the rear panel 12. The support bar 440 may be spaced apart from a side panel 14 by a certain distance and may be coupled to the front panel 13 and the rear panel 12. In one example, the support bar 440 may have both ends coupled to the cabinet 1A, but the remaining portion thereof may be positioned at a location lower than an upper portion of a side surface of the cabinet 1A. As a result, the support bar 440 may be prevented from interfering with the top panel 11 by being spaced apart from the top panel 11. In addition, a space that may support some components of the water supply 300 and the steam unit 200 may be defined between the support bar 440 and the top panel 11.

The support bar 440 may prevent a width of the tank housing 410 from being excessively increased.

In one example, the tank housing 410 may further include a mounting sensor that may sense mounting of the water tank 420 on an inner surface, although not shown. The mounting sensor may be equipped as a weight sensor, and may be equipped to distinguish between light and heavy.

The mounting sensor may be connected to the control panel P and may transmit information on whether the water tank 420 is mounted and an amount of water contained in the water tank 420.

The internal water supply 400 may include a pump discharge pipe 433 that discharges water from the pump housing 430 to the steam unit 200.

The external water supply 500 may include the direct water valve 520 seated on the second support 19A or the rear panel 12, and the direct water pipe 510 that supplies water from the direct water valve 520 to the steam unit 200.

The direct water pipe 510 may extend from the rear panel 12 to the steam unit 200, and the direct water valve 520 may open and close the direct water pipe 510. The direct water pipe 510 may extend from the direct water valve 520 across the support bar 440 to a steam generator 210. In this regard, at least a portion of the direct water pipe 510 may be supported by the support bar 440 and be prevented from coming into contact with the drying drum 3A.

The support bar 440 may be disposed between the direct water valve 520 and the water tank 430.

In addition, the direct water valve 520 may be seated on the rear panel 12 or the second support 19 and exposed to the outside, and the direct water pipe 510 may extend from the direct water valve 520 toward the steam unit 200. Accordingly, the external water supply 500 may supply water to the steam unit 200 in a direct water manner from the external water source.

The steam unit 200 may receive water from each of the external water supply 500 and the internal water supply 400. However, when the steam unit 200 is equipped to receive water via respective pipes, a separate shape of the steam unit 200 should be produced, and a flow channel and a control method may become complicated.

To this end, the laundry treating apparatus of the present disclosure may further include a merging portion 600 that joins the direct water pipe 510 with the pump discharge pipe 433 such that they are joined together. The merging portion 600 may be constructed such that both water stored in the internal water supply 400 and water supplied in the direct water manner from the external water supply 500 are collected.

In addition, the merging portion 600 may transmit supplied water to the steam unit 200. The merging portion 600 may be equipped as a three-way valve, and may also be formed in a shape of a merging pipe to which three pipes are coupled.

When the merging portion 600 is formed in the shape of a pipe, the external water supply 500 and the internal water supply 400 may be equipped with check valves such that backflow may be prevented. Specifically, the direct water pipe 510 may be installed with a direct water check valve 511 that opens the direct water pipe 510 in one direction, and the pump discharge pipe 433 may be installed with a discharge check valve 434 that opens the pump discharge pipe 433 in one direction.

In addition, each of the pump discharge pipe 433 and the direct water pipe 510 may be equipped with a check valve. The external water supply 500 may be equipped with an external check valve, and the internal water supply 400 may be equipped with an internal check valve.

As a result, water supplied to the direct water pipe 510 may be prevented from flowing back to the water pump 430, and water supplied to the pump discharge pipe 433 may be prevented from flowing back to the direct water valve 520.

In one example, when the merging portion 600 is equipped as a valve or a merging pipe, it has considerable self-weight. In addition, when water passes through the merging portion 600, considerable weight may be applied to the merging portion 600.

Therefore, the merging portion 600 may be seated on the support bar 440.

The merging portion 600 and the support bar 440 may be coupled to each other via a separate fixing member, so that the merging portion 600 may be prevented from being separated from the support bar 440. As the merging portion 600 is seated on the support bar 440, locations of the direct water pipe 510 and the pump discharge pipe 433 may also be stably fixed.

In one example, the steam unit 200 may include a water guide pipe 220 connected to the merging portion 600 to receive water from the water supply 300, the steam generator 210 that receives water from the water guide pipe 220 to generate steam, and the steam guide pipe 230 that may guide steam generated from the steam generator 210 to the drying drum 3A or the duct 4.

The steam generator 210 may be disposed downward of the drying drum 3A and stably receive water from the water supply 300 by gravity, and generated steam may stably flow to the drying drum 3A by a density difference.

The steam guide pipe 230 may be in communication with a gasket disposed in front of the drying drum 3A or the first support 17. As a result, the steam guide pipe 230 may stably supply steam into the drying drum 3A without coming into contact with the drying drum 3A.

In one example, the tank housing 410 may be equipped with the mounting sensor that may sense whether the water tank 420 is mounted. For example, the mounting sensor may be equipped as a pressure sensor or the like.

In addition, a water level sensor that may sense a water level of the water tank 420 may be further equipped. For example, the water level sensor may be equipped as a weight sensor. The mounting sensor or the water level sensor may also be controlled by a control panel 820 and may transmit a signal to the control panel 820.

In one example, the control panel P may indirectly identify a water level of the water tank 420 by temporarily operating the water pump 430 and sensing a load added to the water pump 430.

The water storage tank 92 may have a volume considerably greater than that of the water tank 420, and may be disposed to be spaced apart from the water tank 420 to prevent confusion of the user.

The water tank 420 and the steam unit 200 may be disposed between the support bar 440 and one side surface of the cabinet, and the water storage tank 92 may be disposed between the support bar 440 and the other side surface of the cabinet.

Because the water tank 420 is coupled to the tank mounting portion 411, the tank mounting portion 411 may also be viewed as being disposed between the support bar 440 and one side surface of the cabinet.

As a result, the support bar 440 may be disposed between the water storage tank 92 and the steam generator 210, and between the water storage tank 92 and the water tank 420.

The front panel 13 may be fixed to the cabinet body 11 via a panel support 12. That is, the panel support 12 may be fixed to the cabinet body 11, and the front panel 13 may be fixed to the panel support 12.

In this case, the control panel P may be fixed to the cabinet 1 via the panel support 12.

The panel support 12 may be equipped with an interface mounting groove into which the control panel P is fixed.

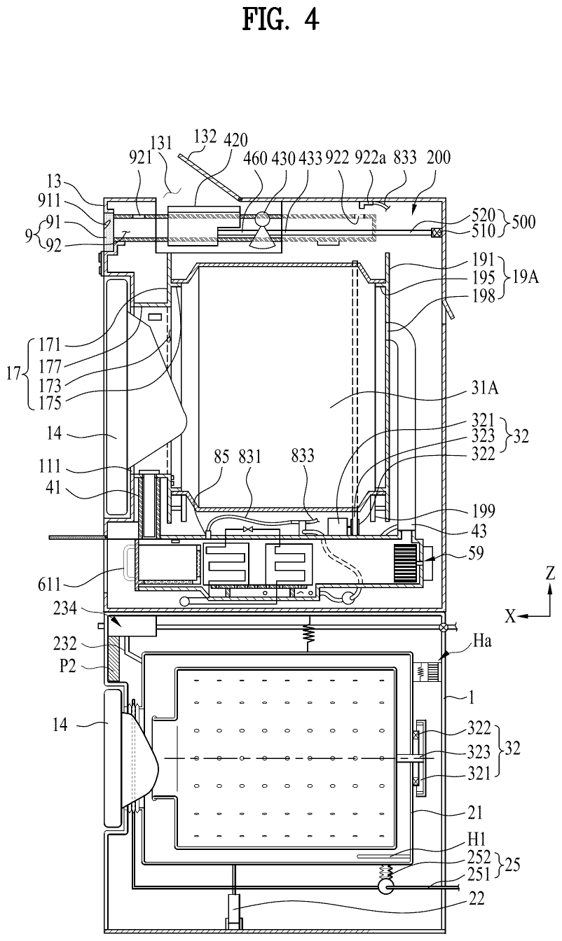

FIG. 4 shows an internal structure of a laundry treating apparatus of the present disclosure when it is equipped as a composite apparatus equipped with the washing machine 10 and the drying machine 20.

Referring to FIG. 4, the washing machine 10 is equipped with the tub 2 and equipped with the heavier driver 32 when compared to the drying machine 20. Therefore, the washing machine 10 may be disposed beneath the drying machine 20.

The configurations of the washing machine 10 and the drying machine 20 may be the same as those of the washing machine 10 and the drying machine 20 described above.

As the cabinet 1, the cabinet 1 of the washing machine 10 and the cabinet 1A of the drying machine may be integrated.

The control panel P may be equipped as the second control panel P2. The second control panel P2 may be disposed at a vertical level corresponding to a space between the tub 2 and the drying drum 3A of the drying machine.

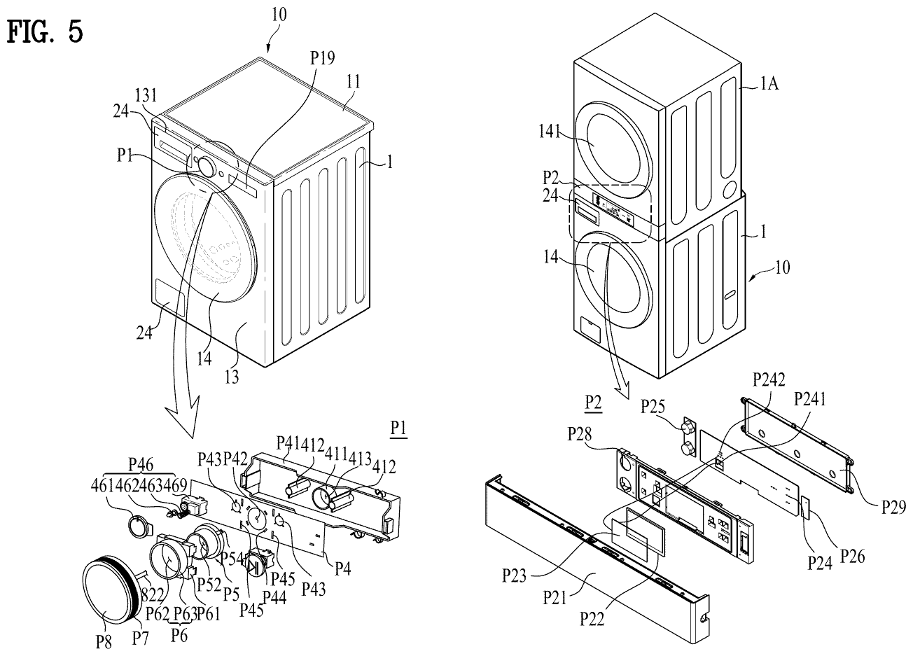

FIG. 5 shows a structure of the control panel P of a laundry treating apparatus of the present disclosure.

(a) in FIG. 5 shows a structure of the first control panel P1, and (b) in FIG. 5 shows a structure of the second control panel P2.

Referring to (a) in FIG. 5, the first control panel P1 may include a circuit board P4 fixed to the panel support 12 and positioned inside the cabinet 1, an encoder P5 fixed to the circuit board and positioned inside the cabinet 1, the rotary knob P7 connected to the encoder P5 by extending through the front panel 13, and the screen P8 fixed to the encoder P5 or to the first circuit board P4 by extending through the front panel 13.

The first circuit board P4, as a board equipped with a control circuit required for control (power control and operation control) of at least one of the driver 32, the steam unit 200, and the water supply 300, may be fixed to the panel support 12 via a casing P41.

The casing P41 may be formed in any shape as long as the first circuit board P4 may be fixed to the panel support 12. The casing P41 may be formed in a hexahedral shape with one surface (a surface facing the panel support) open.

The casing P41 may be equipped with a boss that sets a location of the first circuit board P4. The boss may be composed of a first boss 411 and a second boss 412.

The first circuit board P4 may be equipped with a board through-hole P42 through which the first boss 411 extends, and a boss insertion hole P43 through which the second boss 412 extends. The second boss 412 may be disposed so as to be positioned in each of spaces on left and right sides of the first boss 411, or may be disposed so as to be positioned in each of spaces above and below the first boss 411.

A wire 822 is connected to the display P8. The wire 822 may be equipped as a power line that supplies power to the display, or may be equipped as a communication line that enables the display P8 to be in communication with devices inside the cabinet, including the first circuit board P4.

The first boss 411 may include a first boss through-hole 413, and the panel support 12 may include a wire extension hole 123. The wire 822 may extend into the cabinet 1 by being inserted into the first boss through-hole 413 and the wire extension hole 123.

The first circuit board P4 may further include the power button P46 and the execution button P47. The power button P46 may be equipped as a means for inputting a control command requesting power supply to the laundry treating apparatus 100, and the execution button P47 may be equipped as a means for inputting a command requesting execution of a control command displayed on the display P8 or a command requesting temporary suspension of the control command being executed by the laundry treating apparatus 10.

The power button P46 and the execution button P47 may generate control signals by sensing static electricity from a user's body.

The power button P46 may include a first button 461 exposed to the outside of the cabinet 1, a first sensor 464 fixed to the first circuit board P4, and a conductor (a first touch spring) 463 connecting the first button with the first sensor. Likewise, the execution button P47 may include a second button 471 exposed to the outside of the cabinet 1, a second sensor 474 fixed to the first circuit board P4, and a conductor (not shown, a second touch spring) connecting the second button with the second sensor.

The front panel 13 includes a first button mounting portion 136 and a second button mounting portion 117. The first button 461 may be exposed to the outside of the cabinet 1 via the first button mounting portion 116, and the second button 471 may be exposed to the outside of the cabinet 1 via the second button mounting portion 117.

The power button P46 and the execution button P47 may be disposed separately in left and right spaces of the screen P8, may be disposed separately in upper and lower spaces of the display, or may be disposed vertically or horizontally in either the left or right space of the display.

The first touch spring 463 and the second touch spring may be formed in a coil shape, which is intended to provide a restoring force to the first button 461 and the second button 471. Furthermore, to prevent the first button 461 and the second button 471 from being deviated from the respective button mounting portions 116 and 117, the power button 46 may include a first stopper 462 that limits a range of motion of the first button, and the execution button 47 may include a second stopper (not shown) that limits a range of motion of the second button.

The encoder P5 is a means for rotatably fixing the manipulator P7 to the first circuit board P4, and also is a means for generating an electric signal when the rotary knob P7 is rotated (or generating an electric signal set differently based on a rotation angle of the actuator).

The encoder P5 may include a fixed portion P51 fixed to the first circuit board P4 and to which the screen P8 is fixed, a rotatable portion P52 rotatably disposed on the fixed portion P51 and to which the rotary knob P7 is fixed, and a signal generator P54 that generates the electric signal when the rotatable portion P52 is rotated.

The first circuit board P4 on which the encoder P5 is assembled may be coated with an insulating material. This is to minimize a possibility of water being supplied to the first circuit board P4 and causing a short circuit. To prevent the rotatable portion P52 from being fixed to the fixed portion P51 by the insulating material when the insulating material is coated on one surface (a surface facing the front panel) of the first circuit board P4, the control panel P may further include an encoder cover P6.

The encoder cover P7 may be formed in a pipe shape that is fixed to the first circuit board P4 and surrounds the encoder P5. That is, as shown in the drawing, the encoder cover P6 may include a fixed body cover P61 that is fixed to the first circuit board P4 and surrounds the fixed body 512, and a cover through-hole P62 that extends through the fixed body cover P61 and into which the encoder 5 is inserted.

The fixed body cover P61 may include a board fastener 611, and the first circuit board P4 may include an encoder cover fixing hole P45 to which the board fastener 611 is fixed.

The encoder cover P6 may further include a support body cover P63 that extends from the fixed body cover P61 and surrounds the rotatable portion P52 (surrounds the support body). Because the support body cover P63 may restrict the rotary knob P7 from moving in a radial direction of the cover through-hole 62, the support body cover 63 may prevent the rotary knob P7 from being separated from the rotatable portion P52.

Referring to (b) in FIG. 5, the second control panel P2 may include a cover panel P21 coupled to the cabinet 1, a control board P24 disposed at the rear of the cover panel P21, and a liquid crystal display P22 disposed between the control board P24 and the cover panel P21 to externally display information transmitted from the control board P24.

The cover panel P21 may be coupled to the cabinet 1 to prevent the control board P24 and the liquid crystal display P22 from being exposed to moisture or colliding directly with an external object or the like.

The cover panel P21 may be equipped as a reinforced resin-based or metal plate, and may have an area corresponding to the control board P24 or the liquid crystal display P22 made of a transparent material that allows light to pass therethrough.

In one example, the cover panel P21 may be made of a material that may be charged by current generated from the user's body, or a material that may pass the current to the liquid crystal display P22.

In one example, a touch film P23 may be further disposed such that the display liquid crystal P22 may perform a function of a touch panel.

The touch film P23 may be equipped as a transparent thin film that is equipped to sense not only the current received from the user's body, but also coordinates to which the current has reached.

The control board P24 may include a display controller P241 electrically connected to the liquid crystal display P22, and a touch receiver P242 electrically connected to the touch film P23.

The liquid crystal display P22 may receive and display information by being connected to the display controller P241 by a wire, and may display various touch information at coordinates corresponding to an input of the touch film P23.

The touch film P23 may have an area size corresponding to that of the liquid crystal display P22, and may transmit, to the touch receiver P242, whether the user's body is in contact with or close to the coordinates displayed in the touch information.

Accordingly, the liquid crystal display P22 may perform a role of the touch panel.

In one example, the control board P24 may sense the user touching the power area P25 and the execution area P26.

However, the second control panel P2 of the present disclosure has the power area P25 and the execution area P26 disposed separately from the control board P24 to clearly distinguish the touch of the power area P25, the touch of the execution area P26, and the touch of the display liquid crystal display P22 from each other.

The power area P25 may be equipped as a PCB that is disposed separately from the control board P24 and senses a user's touch, and the power area P25 may include a light-emitter that may irradiate light to the cover panel P21.

The execution area P26 may be equipped as a PCB that is disposed separately from the control board P24 and senses a user's touch, and the execution area P26 may include a light-emitter that may irradiate light to the cover panel P21.

That is, the power area P25 and the execution area P26 may not be equipped as liquid crystal displays, but may be equipped as circuit boards that may sense input of current, and may include the light-emitters for guiding touch areas.

The second control panel P2 of the present disclosure may further include a support panel P28 that supports the power area P25, the execution area P26, and the control board P24, and provides a space for seating the liquid crystal display P22 and the touch film P23.

The support panel P28 may be made of a resin-based material, and may be formed in a shape that may accommodate and support the power area P25, the execution area P26, and the control board P24.

In addition, the support panel P28 may accommodate and support outer peripheral surfaces of the liquid crystal display P22 and the touch film P23.

In one example, a fixing panel P29 that may be coupled to a rear side of the support panel P28 and fix the power area P25, the execution area P26, the control board P24, the liquid crystal display P22, and the touch film P23 may be included.

The fixing panel P29 may be coupled to the support panel P28 via a fastening member such as a bolt.

The support panel P28 may be coupled to and fixed to a frame or the like forming the cabinet 1, or may be fixed by being seated on a bent surface formed by bending an outer peripheral surface of the cover panel P21.

As a result, all other components of the second control panel P2 may be accommodated and seated between the cover panel P21 and the fixing panel P29.

In one example, as described above, the control panel P of the present disclosure may be equipped as one of the first control panel P1 including a rotary knob and a screen and the second control panel P2 equipped in a touch panel manner, depending on the form of the laundry treating apparatus.

In addition, unlike the structure described above, the control panel P of the present disclosure may be equipped as a third control panel P3 to be described later, which has all components that receive the user input as physical buttons and displays visual information with a light-emitter like a simple bulb.

The control panel P of the present disclosure may be equipped with various structures, but the control panel P of the present disclosure may perform a role of an interface I that receives a user's command, displays information to the user, and is in communication with the user in the laundry treating apparatus 100.

Therefore, even when the control panel P of the present disclosure is equipped with the various structures, the control panel P of the present disclosure may be distinguished by centered on the fact that it performs the role or function of the interface I rather than the structure thereof.

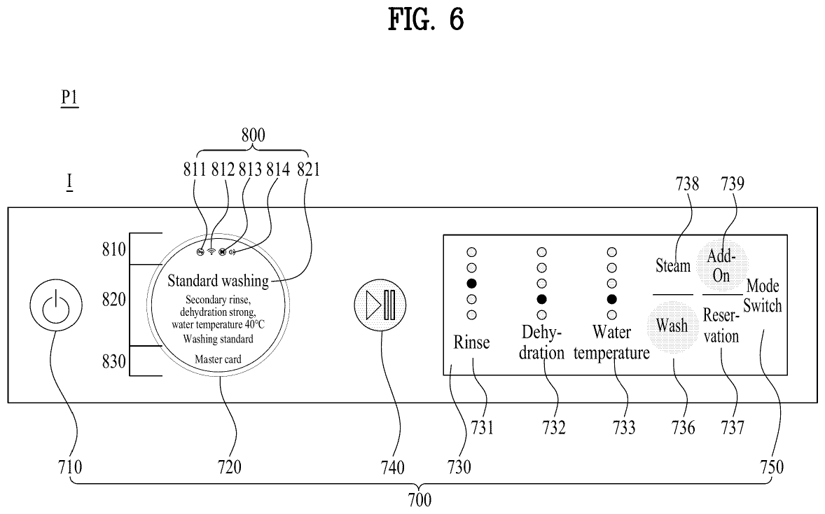

FIG. 6 shows an embodiment of the first control panel P distinguished to be the interface I.

The first control panel P of the present disclosure may include a power unit 710 that receives a power command for supplying power to the laundry treating apparatus or the control panel P, a course selector 710 that receives a selection command of selecting an arbitrary course that may perform the treatment of the laundry, an option selector 730 that receives a selection command of an arbitrary option of selecting conditions of the course, and an execution unit 740 that receives an execution command for performing the selected course and option.

The course for treating the laundry may be viewed as a series of control methods that may perform one of the washing cycle of removing the foreign substances from the laundry with water and detergent, the rinsing cycle of removing the foreign substances from the laundry and the detergent, the dehydration cycle of removing water from the laundry using the centrifugal force or the like, the drying cycle of removing moisture from the laundry using at least one of air and steam, and the refreshing cycle of performing at least one of the deodorization, the wrinkle removal, and the sterilization of the laundry using at least one of air and steam.

The options of the course may be viewed as a series of algorithms that include various conditions for performing the course, the number of repetitions, a duration, a performance intensity, and additional functions that may be added.

In the first control panel P, the power button P46 may be defined as the power unit 710, the execution button P47 may be defined as the execution unit 740, the rotary knob P7 may be defined as the course selector 710, and the setting area P19 may be defined as the option selector 730.

For example, the option selector 730 may be equipped as a touch display that may select the arbitrary option, and may be equipped with a plurality of lamps and a plurality of conductor switches that may sense the user's body.

The option selector 730 may include a rinsing adjustor 731 that adjusts a rinsing intensity related to rotation speed and duration of the drum, an amount of water, and the number of rinsing cycles when the course performs the rinsing cycle, a dehydration adjustor 732 that adjusts a dehydration intensity related to rotation speed and duration of the drum when the course performs the dehydration cycle, and a temperature adjustor 733 that adjusts a temperature of water when the course performs the washing cycle.

In one example, the option selector 730 may receive the additional function of the course.

In the option selector 730, a washing adjustor 734, the rinsing adjustor 731, the dehydration adjustor 732, and the temperature adjustor 733 may be largely categorized into a condition setting unit that selects an option related to a cycle condition for performing the course, and a function setting unit that sets additional functions other than the cycle condition of the course, such as reservation of time when the course is performed or terminated, whether to supply steam, sterilization of the drum 3 and the tub 2, and wrinkle prevention.

Specifically, the function setting unit of the option selector 730 may include a washing unit 736 that may input a washing option for performing a special washing cycle, such as a functional laundry, a soft laundry, and a tub cleaning, a reservation manager 737 that inputs a reservation command for performing a washing course at a specific time, a sterilization unit 738 that may select a sterilization option that may add steam to the laundry during the course cycles to achieve sterilization, and an additional function unit 739 that performs a course received from a server or selects adding additional options.

In one example, a switching button E that receives a switching command that allows the first control panel P to control another laundry treating apparatus or be in communication with an external terminal may be defined as a switching unit 750.

The power unit 710, the course selector 720, the option selector 730, the execution unit 740, and the switching unit 750 may be collectively referred to as an input unit 700 in that they perform the functions of receiving the various commands from the user.

The first control panel P may further include a display 800 that may display information corresponding to the input of the input unit 700 to the user or may visually display guidance information for the user, state information of the laundry treating apparatus, and the like to the user.

The display screen P8 in the first control panel P may be defined as the display 800.

The display 800 may be divided into a state display 810, a content display 820, and an input display 830 based on functions.

For example, the state display 810 may display whether the door 14 is locked, whether the communication module is activated, whether the course or the option is in operation, whether a guidance phrase is generated, and the like in a form of an icon.

In addition, the number of information to be displayed may be displayed in a form of icon or symbol on the state display 810. For example, a plurality of dots may be arranged to be spaced apart from each other, and one of the plurality of dots may emit light and display the total number of information that may be checked on the content display 820.

The content display 820 may display information on the sensed laundry or amount of laundry, specific details of the selected course or option, a state in which the course or the option is being executed, and the guidance information required for the user as text or image 821.

The information on the laundry or the amount of laundry displayed on the content display 820 may include information on a weight of the laundry and an amount of detergent required to treat the laundry.

Content of the selected course displayed on the content display 820 may include a type of course suitable for treating laundry of a specific material or a specific load (what to wash), a duration of the course, a remaining time of the course, and the like. Therefore, the content display 820 may perform a role of a course display.

In addition, content of the selected option displayed on the content display 820 may be information on how to execute the course (how to wash), such as the number of repetitions of cycles of washing, rinsing, dehydration, and the like performed in the course, an intensity of the cycle, a temperature at which the cycle is performed, and the like. The content display 820 may also serve as an option display.

The content display 820 may display the state and the function of the laundry treating apparatus in detail and variably. Therefore, the content display 820 may be larger than the state display 810.

The input display 830 may emit light to prompt the user to press the input unit 810 or press the touch area or the like defined on the display 800, and may display a guide text regarding what content the user may input.

The display 800 may be equipped entirely as a touch panel.

In addition, in the display 800, the content display 820 may be equipped as a liquid crystal display that may display a screen, the state display 810 may be equipped as a plurality of light bulbs that may selectively emit light, and the input display 830 may be composed of various means that may input a user's touch and light bulbs that may selectively emit light.

In one example, the display 800 may further include an option display 840 that may display selection information regarding the option.

The option display 840 may display option information corresponding to the option selector 730. That is, the option display 840 may be equipped as an area where conditions of the course selected via the option selector 730 are displayed.

The option display 840 may display rinsing power, dehydration power, and temperature in an objective and unitary manner.

For example, the option display 840 may be divided into sections corresponding to different levels of rinsing intensity, dehydration intensity, and water temperature selected by the option selector 730, and the section corresponding to the set level may be illuminated. The option display 840 may indicate a current level of the selected option.

When the content display 820 is able to display specific content of the confirmed option, the option display 840 may display an entire range from which a specific option may be selected and an intensity at which the specific option is selected.

In one example, the option display 840 and the option selector 730 may be controlled such that functions that are currently available or functions selected by the user are lit, and functions that are not able to be executed or are not selected by the user are turned off.

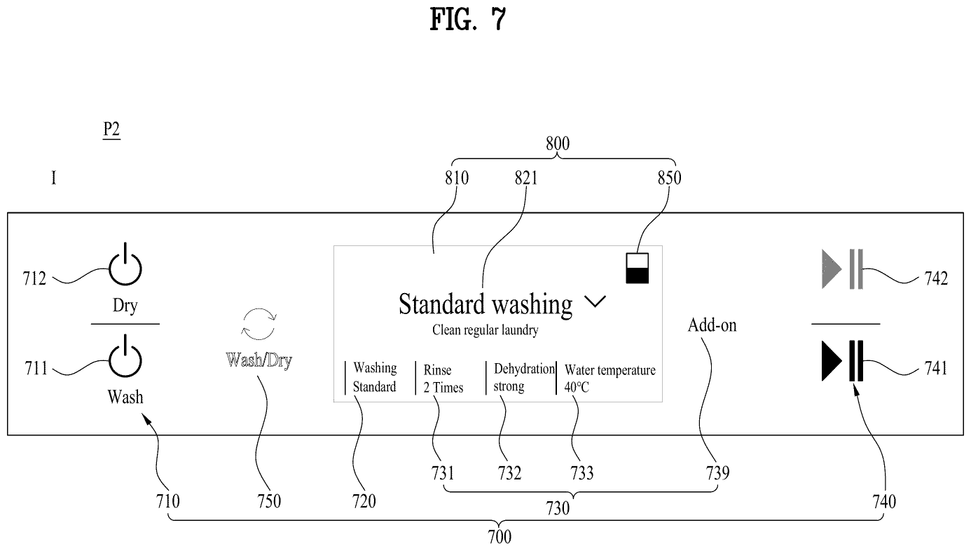

FIG. 7 shows an embodiment of the second control panel P2 distinguished to be the interface I.

The second control panel P2 of the present disclosure may include the input unit 700 including the power unit 710 that receives the power command for supplying the power to the laundry treating apparatus or the control panel P, the course selector 710 that receives the selection command for selecting the arbitrary course capable of performing the laundry treatment, the option selector 730 that receives the selection command of the arbitrary option for selecting the conditions of the course, and the execution unit 740 for receiving the execution command for executing the selected course and option.

Functions of the respective components of the input unit 700 of the second control panel P2 may be the same as those of the input unit 700 of the first control panel P1.

In addition, the second control panel P2 may further include the display 800 that may display the information corresponding to the input of the input unit 700 to the user or may visually the display guidance information for the user, the state information of the laundry treating apparatus, and the like to the user.

The function of the display 800 of the second control panel P2 may be the same as that of the display 800 of the first control panel P1.

In the second control panel P2, the power area P25 may be defined as the power unit 710, the execution area P26 may be defined as the execution unit 740, and the switching area P27 may be defined as the switching unit 750.

In the second control panel P2, the course and the option may be selected via the touch film P23. Therefore, the touch film P23 may be defined as the course selector 720 and the option selector 730.

In one example, the liquid crystal display P22 may be defined as the display 800.

Specifically, in the second control panel P2, the power unit 710 may include a first power unit 711 that receives a power command of the washing machine 10 and a second power unit 712 that receives a power command of the drying machine 20.

In addition, the execution unit 740 may include a first executor 741 that receives an execution command of the washing machine 10 and a second executor 742 that receives an execution command of the drying machine 20.

The switching unit 750 may be disposed between the power unit 710 and the display 800.

The liquid crystal display P22 and the touch film P23 are disposed to overlap each other. As a result, it may be seen that the display 800 and the input unit 710 are divided from each other based on a display area of the liquid crystal display P22.

For example, in the liquid crystal display P22, a lower area may be defined such that the course and the option are selected, and an upper area and a central area may be defined to display various information.

In the liquid crystal display P22, the upper area may perform a role of the state display 810, and the central area may perform a role of the content display 820.

In the content display 820, the information on the sensed laundry or amount of laundry, the specific details of the selected course or option, the state in which the course or the option is being executed, and the guidance information required for the user may be displayed as the text or image 821.

The information on the laundry or the amount of laundry displayed on the content display 820 may include the information on the weight of the laundry and the amount of detergent required to treat the laundry.

The content of the selected course displayed on the content display 820 may include the type of course suitable for treating the laundry of the specific material or the specific load (what to wash), the duration of the course, the remaining time of the course, and the like. Therefore, the content display 820 may perform the role of the course display.

In addition, the content of the selected option displayed on the content display 820 may be the information on how to execute the course (how to wash), such as the number of repetitions of cycles of washing, rinsing, dehydration, and the like performed in the course, the intensity of the cycle, the temperature at which the cycle is performed, and the like. The content display 820 may also serve as the option display.

In one example, in the display 800, the course selector 720 and the option selector 730 that may receive the selection of the course/option may be disposed in the lower area.

Because the lower area of the display 800 receives the selection of the course/option, it may be viewed as performing the role of the input display 830.

The course selector 720 may be displayed at a left lower end of the liquid crystal display P22. When the course selector 720 is pressed, the liquid crystal display P22 may switch to display various courses provided by the laundry treating apparatus of the present disclosure, scattered across at least one of the content display 820, the state display 810, and the input display 830, and the specific course may be selected by sensing that a specific area of the touch film P23 is pressed.

The option selector 730 may be disposed on one side of the course selector 720 on the liquid crystal display P22.

The rinsing adjustor 731, the dehydration adjustor 732, and the temperature adjustor 733 may be arranged to be separated from each other.

When one of the rinsing adjustor 731, the dehydration adjustor 732, and the temperature adjustor 733 is pressed, optional conditions that may be changed may be displayed in a scattered manner on at least one of the content display 820, the state display 810, and the input display 830 of the liquid crystal display P22, and the option may be changed by sensing that a specific area of the touch film P23 is pressed.

In one example, because the lower area 830 displays content corresponding to the option, it may be considered to also perform the role of the option display 840.

The additional function unit 739 may be equipped as a separate input unit. When the additional function unit 739 is pressed, the washing unit 736, the reservation manager 737, and the sterilization unit 738 may be displayed together on the display 800, so that the additional function of the course may be input to the touch film P23.

In one example, the display 800 may further include a switching display 850 that indicates whether the information currently displayed on the display 800 is related to either the washing machine 10 or the drying machine 20.

For example, when a lower portion is illuminated, the display 800 may display the information related to the washing machine 10 that is disposed at the bottom.

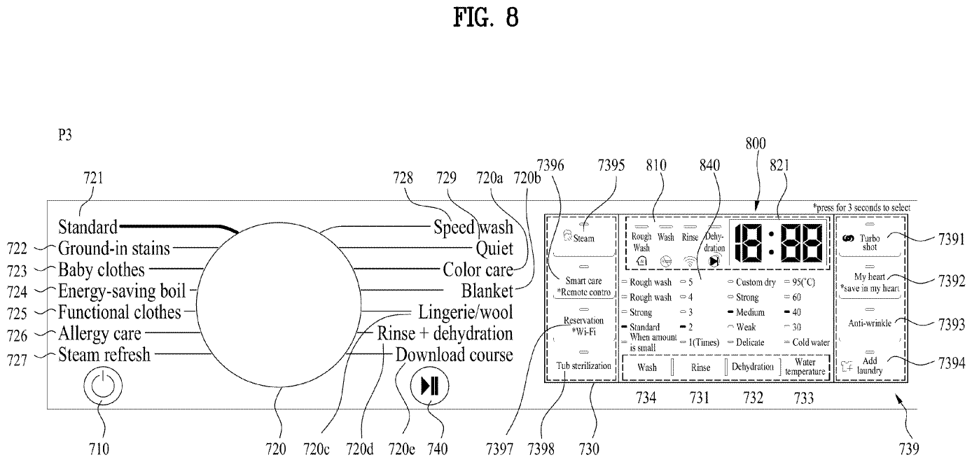

FIG. 8 shows an embodiment of the third control panel P distinguished to be the interface I.

The third control panel P3 of the present disclosure may include the input unit 700 including the power unit 710 that receives the power command for supplying the power to the laundry treating apparatus or the control panel P, the course selector 710 that receives the selection command for selecting the arbitrary course capable of performing the laundry treatment, the option selector 730 that receives the selection command of the arbitrary option for selecting the conditions of the course, and the execution unit 740 for receiving the execution command for executing the selected course and option.

Functions of the respective components of the input unit 700 of the third control panel P3 may be the same as those of the input unit 700 of the first control panel P1.

In addition, the third control panel P3 may further include the display 800 that may display the information corresponding to the input of the input unit 700 to the user or may visually the display guidance information for the user, the state information of the laundry treating apparatus, and the like to the user.

The function of the display 800 of the third control panel P3 may be the same as that of the display 800 of the first control panel P1.

Specifically, the third control panel P3 may be equipped with the power unit 710 and the execution unit 740 as separate buttons.

The control panel P3 may be equipped with the course selector 720 as a rotary knob.

The course selector 720 may be disposed between the power unit 710 and the execution unit 740, and a name of a course corresponding to each tick of the rotary knob's rotational steps may be printed on a surface of the third control panel P3 on the outside of the rotary knob.

The display 800 may be disposed to be spaced apart from the course selector 720.

In one example, the option selector 730 may be equipped as a separate button combination by being spaced apart from the course selector 720, and may be disposed along a perimeter of the display 800.

The course selector 720 may include a standard course unit 721 that selects a standard course to treat the laundry with appropriate intensity and appropriate temperature condition by selecting an average material of the entire laundry that users generally treat.

The average material may be cotton or a T-shirt material, the appropriate intensity may be an intensity that corresponds to a middle level among those provided by the laundry treating apparatus, and the appropriate temperature condition may be a cold water condition.

The course selector 720 may further include an intensive course unit 722 of selecting a stained clothes course that treats the laundry with higher strength and higher temperature condition than the standard course, a baby clothes course unit 723 of selecting a baby clothes course that treats laundry made of a softer material than that of the standard course, a boiling course unit 724 of selecting a boiling course that treats the laundry for a longer time than the standard course using hot water or the heater H1, a functional course unit 725 of selecting a functional course that treats functional laundry such as waterproof or Gore-Tex laundry, an allergy course unit 726 of selecting an allergy care course that performs the sterilization by exposing the laundry to a high temperature equal to or higher than 50 degrees for a sterilization time of 10 minutes or longer, a steam course unit 727 of selecting a steam course that supplies steam to the laundry by heating water via the heater H1 or the like, a speed course unit 728 of selecting a quick course that treats the laundry with a shorter execution time than the standard course, a quiet course unit 729 of selecting a quiet course that treats the laundry with an average rotation speed of the drum lower than that in the standard course, a color course unit 720a of selecting a color course that uses a lower temperature or a lower average rotation speed of the drum than that of the standard course to prevent color transfer and discoloration of the laundry, a comforter course unit 720b of selecting a comforter course that treats laundry made of a material with a higher moisture absorption rate than the material of the laundry suitable for the standard course and has a great weight, a wool course unit 720c of selecting a wool course that treats the laundry by minimizing the rotation speed of the drum or minimizing the operating time of the drum to treat laundry made of a material softer than the material of the laundry suitable for the standard course, a rinsing course unit 720d of selecting a rinsing course that treats the laundry only with water without using the detergent, and a download course unit 720e of selecting special courses such as a course provided by other servers or a time course in which the user determines the execution time of the course.

In one example, the surface of the third control panel P3 may display the type of course corresponding to the course selector 720. On the third control panel P3, the type of course may be indicated by being printed, or the type of course specified via the course selector 720 may be indicated by being illuminated in a manner such as a light bulb. Therefore, it may be seen that the surface of the third control panel P3 performs the role of the course display.

In one example, the option selector 730 may include the washing adjustor 734 that may select a washing intensity of the laundry, the rinsing adjustor 731 that may select a rinsing intensity of the laundry, the dehydration adjustor 732 that may select a dehydration intensity of the laundry, and the temperature adjustor 733 that may select a temperature condition of the laundry, as condition setting units.

In the displays 800, the option display 840 may be disposed upward of the washing adjustor 734, the rinsing adjustor 731, the dehydration adjustor 732, and the temperature adjustor 733 to externally display the cycle conditions selected via the option selector 730.

In one example, the option selector 730 may include, as function setting units 739, a steam unit 7395 of selecting a steam option that supplies steam into the drum 3, a smart care unit 7396 of selecting a remote control option that performs the course with an external terminal, a reservation manager 7397 of selecting an option for setting a start time or an end time of the course, a tub sterilization unit 7398 of selecting an option that cleans and sterilizes the drum 3 and the tub 2 with high-temperature water and a rotational force of the drum, a turbo shot unit 7391 of selecting an option that generates a strong water flow inside by rotating the drum faster in the washing cycle and the rinsing cycle, a user setting unit 7392 of selecting an option to treat the laundry with washing intensity, rinsing intensity, and dehydration intensity specified by the user, an anti-wrinkle unit 7393 of selecting an option to prevent wrinkling of the laundry by intermittently rotating the drum after the course ends, a laundry addition unit 7394 of selecting an option to allow the door to be opened to add the laundry during the course, and the like.

The display 800 may include the state display 810 and the content display 820 described above.

The state display 810 may display the current state of the laundry treating apparatus with various icons as described above, and the content display 820 may display information 821 such as a progress time or expected time of the course, or a reservation time in text, numbers, images, or the like.

For example, the content display 810 of the third control panel P3 may be equipped with a plurality of light bulbs that turn on or off respective corresponding areas, rather than a liquid crystal display that displays the screen variably.

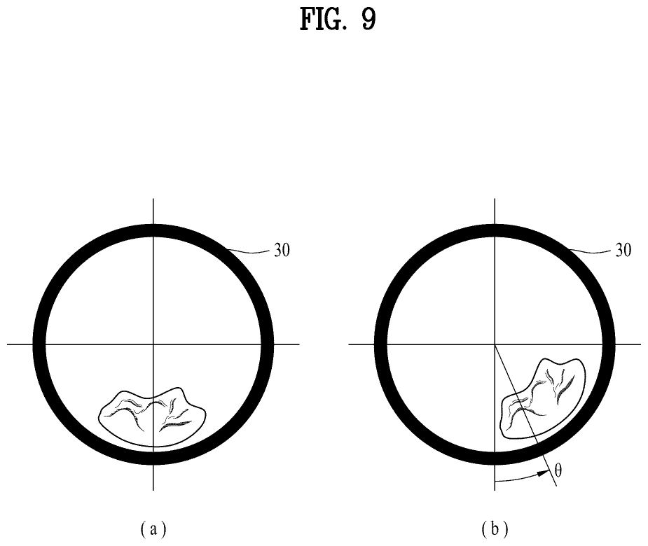

FIG. 9 shows an aspect of a laundry treating apparatus of the present disclosure sensing an amount of laundry based on the above-described configuration.

The laundry treating apparatus of the present disclosure may perform the laundry amount sensing before the execution unit 740 is pressed.

Specifically, the laundry treating apparatus of the present disclosure may sense the amount of laundry by rotating the drum 3 when the power unit 710 is pressed or the opening/closing of the door 14 is sensed.

In addition, when the laundry is input to the drum 3 and vibrations or the like are transmitted to the driver 80, the drum 3 may be immediately rotated less than once to sense the amount of laundry.

As a result, because the drum 3 is rotated less than once, even when the user inputs the laundry with the door 132 open, the amount of laundry may be sensed without a possibility of the user being injured or the laundry being damaged.

Therefore, the amount of laundry may be sensed before selecting the course or the option with the course selector 720 or before executing the course or the option with the execution unit 740. For the sensed amount of laundry, an appropriate amount of detergent may be recommended, an appropriate course may be recommended, or an expected execution time or a completion time of the course may be displayed immediately while the user is looking directly at the display 800.

Therefore, the user may be encouraged to increase utilization of the laundry treating apparatus, and the user may be accurately informed of a time of collection of the laundry.

In one example, the laundry treating apparatus of the present disclosure may be equipped with a weight sensor in the tub 2, the drum 3, or the driver 80 to directly sense the amount of laundry.

Hereinafter, an embodiment of a laundry treating apparatus of the present disclosure that senses an amount of laundry via rotation of the drum 3 will be described.

Referring to (a) in FIG. 9, the laundry may be disposed on the bottom surface of the drum 3 because of an own weight thereof.

Referring to (b) in FIG. 9, when sensing the amount of laundry, the laundry treating apparatus of the present disclosure may rotate the drum 3 less than once.

That is, the laundry treating apparatus of the present disclosure may rotate the drum 3 by an angle equal to or smaller than an angle at which the laundry is separated from the drum inner wall or an arrangement thereof is changed. As a result, unnecessary load or impact may be prevented from being transmitted to the driver 32 as the location of the laundry changes inside the drum 3.

As a result, the laundry treating apparatus of the present disclosure may accurately transmit the current value applied to or output from the driver 32 to the controller C, and accurately calculate the amount of laundry.

For example, the laundry treating apparatus of the present disclosure may rotate the drum in a range of 0 degrees to 90 degrees when sensing the amount of laundry.

In one example, the smaller the rotation angle of the drum 3, the shorter the time it takes for the controller C to sense the amount of laundry, and the less the error in sensing the weight of the laundry.

Therefore, the laundry treating apparatus of the present disclosure may rotate the drum 3 in a range of 10 degrees to 45 degrees when sensing the amount of laundry.

As a result, the laundry treating apparatus of the present disclosure may sense the amount of laundry quickly and accurately.

Therefore, the laundry treating apparatus of the present disclosure may sense the amount of laundry immediately and display information related to the amount of laundry on the display 800 when sensing the pressing of the power unit 710 or the opening/closing of the door 14 before the execution unit 740 is pressed.

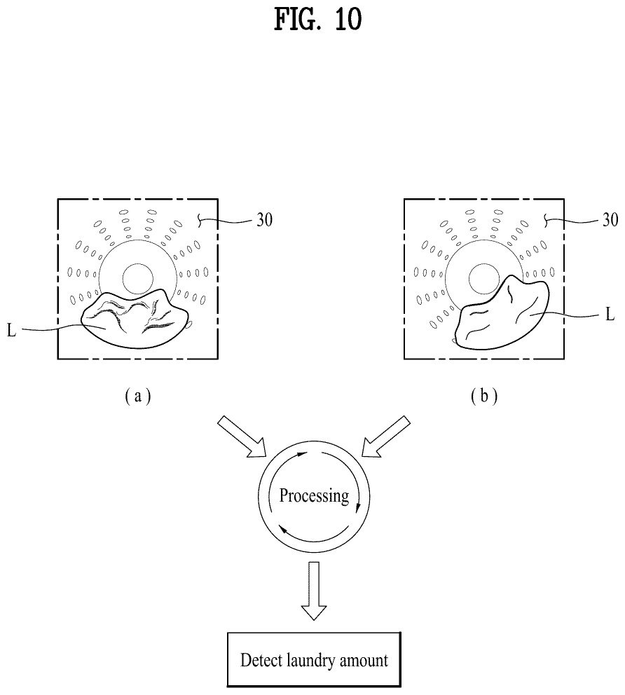

FIG. 10 shows a calculation scheme in laundry amount sensing of a laundry treating apparatus of the present disclosure.

Referring to (a) and (b) in FIG. 10, the controller C may rotate the drum 3 less than once, and in such process, measure the current value applied to or output from the driver 32.

The controller C may calculate (process) the amount of laundry based on the current value.

Specifically, the controller C may use a formula Te=Jdw/dt+Bw+mgrsin Θ to sense the amount of laundry.

Te is a torque value applied to the driver 32, which corresponds to I (current value) X K (driver constant).

That is, because the driver constant k is a unique value of the driver 32 itself, the controller C may calculate the torque value applied to the driver 32 when it senses the current value I.

In this regard, in a case of sin Θ in mgrsin Θ, because the value decreases exponentially as the rotation angle of the drum decreases, sine may be sufficiently ignored when the rotation angle is in a range of 15 degrees to 90 degrees or in a range of 10 degrees to 45 degrees.

In addition, Bw is a friction torque, and is able to be ignored because B becomes very small when the drum 3 rotates.

As a result, only a formula Te=Jdw/dt may remain.

In this regard, because dw/dt is an angular acceleration that rotates the drum, the controller C may sense the angular acceleration in the process of rotating the drum when sensing the amount of laundry. The angular acceleration may be directly calculated via the current value applied to the driver 32. A method of calculating the angular acceleration with the current value will be described later.

Therefore, because both the torque value Te applied to the driver 32 and the angular acceleration dw/dt may be calculated by measuring the current value, a moment of inertia J may be calculated.

As a result, the laundry treating apparatus of the present disclosure may immediately sense the amount of laundry by identifying the moment of inertia J.

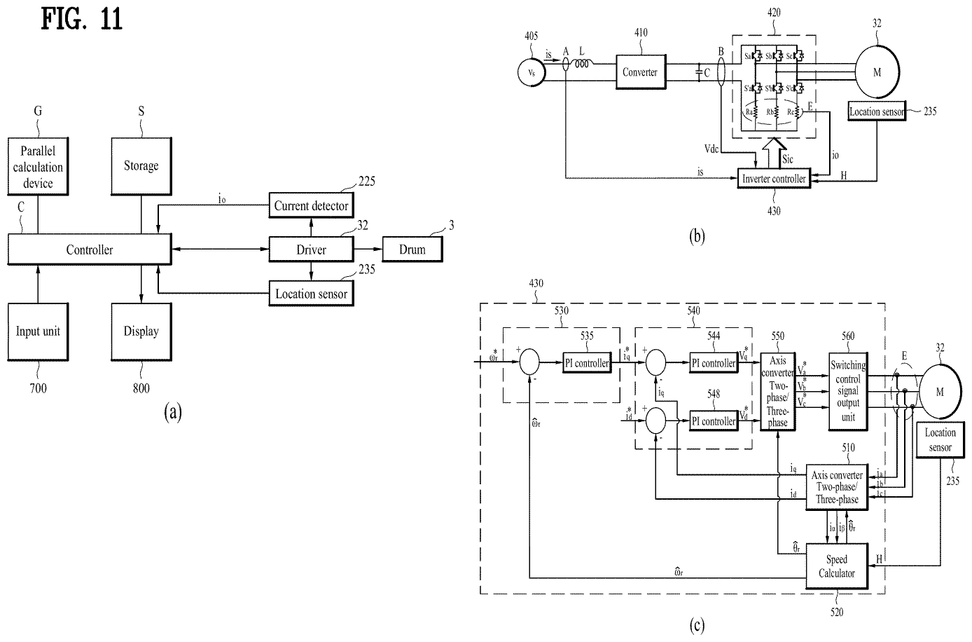

FIG. 11 shows a basic structure in which the controller C may measure the current value of the driver 32 in the laundry treating apparatus of the present disclosure.

Referring to (a) in FIG. 11, the controller C may control the driver 32 by applying current to the driver 32, and may sense the current discharged from the driver 32.

The controller C controls the driver 32 based on a preset course or option, and the driver 32 rotates the drum 3 in response to a command of the controller C.

The controller C operates by receiving an operation signal or a control command from the course selector 720, the execution unit 740, or the option selector 730. Washing course and option to perform the washing, rinsing, and dehydration cycles may be selected via the course selector 720 or the option selector 730.

Accordingly, the washing, rinsing, and dehydration cycles may be performed. In addition, the controller C may control the display 800 to display the washing course, the washing time, the dehydration time, the rinsing time, the current operation state, or the like.

The controller C may control the driver 32 to rotate the drum 3 and also vary the rotation speed of the drum 3. Specifically, the controller C may control the driver 32 based on at least one of a current detector 225 that detects an output current flowing through the driver 32 and a location sensor 220 that senses a location of the driver 320. For example, either the current detected by the driver 32 or the sensed location signal may be fed back to the controller C, and the controller C may generate a current signal that may appropriately control the driver 32 based on the feedback signal.

In one example, the laundry treating apparatus of the present disclosure may sense the location of the driver 32 by omitting the location sensor 235 and implementing a separate algorithm (as known as a sensorless driver). The sensorless driver 32 may be constructed to identify a location of the rotor or the stator as the controller C measures the current or voltage output from the driver 32.

Hereinafter, an embodiment in which the controller C controls the driver 32 will be described.

The driver P may be equipped as a three-phase motor such that the rotation speed thereof may be controlled, and may be equipped as, for example, a BLDC motor.

Referring to (b) in FIG. 11, the controller C may include an inverter 420 and an inverter controller 430 to control the aforementioned rotor and stator. In addition, the controller C may further include a converter 410 that supplies DC power to be input to the inverter 420, or the like.

That is, the controller C may also perform a role of the inverter controller 430 at the same time. In one example, the inverter controller 430 may be formed separately from the controller C. When the inverter controller 430 outputs a switching control signal Sic in a pulse width modulation (PWM) scheme to the inverter 420, the inverter 420 may perform a high-speed switching operation to supply AC power of a predetermined frequency to the rotor 913 and the stator 911.

The laundry treating apparatus of the present disclosure may further include, in addition to the converter 410, the inverter 420, and the inverter controller 430, a DC terminal voltage detector B, a smoothing capacitor C, and an output current detector E. In addition, the laundry treating apparatus of the present disclosure may further include an input current detector A, a reactor L, and the like.

The reactor L is disposed between a commercial AC power source (vs) 405 and the converter 410, and performs a power factor correction or boosting operation. In addition, the reactor L may also perform a function of limiting harmonic current caused by high-speed switching of the converter 410.

The input current detector A may detect an input current is input from the commercial

AC power source 405. To this end, a current transformer (CT), a shunt resistor, and the like may be used as the input current detector A. The detected input current is may be input to the inverter controller 430 as a discrete signal in a form of a pulse.

The converter 410 converts power from the commercial AC power source 405 that has passed through the reactor L into DC power and outputs the DC power. In the drawing, the commercial AC power source 405 is shown as a single-phase AC power source, but is also able to be a three-phase AC power source. An internal structure of the converter 410 also varies depending on a type of commercial AC power 405.

In one example, the converter 410 may be composed of diodes or the like without a switching element, and may perform a rectification operation without a separate switching operation. For example, in a case of the single-phase AC power source, four diodes may be used in a bridge form, and in a case of the three-phase AC power source, six diodes may be used in the bridge form.

As the converter 410, a half-bridge-type converter in which two switching elements and four diodes are connected may be used, and in the case of the three-phase AC power source, six switching elements and six diodes may be used. When the converter 410 has the switching element, a boost operation, power factor improvement, and DC power conversion may be performed via the switching operation of the corresponding switching element.

The smoothing capacitor C smooths the input power and stores the same. In the drawing, one element is exemplified as the smoothing capacitor C, but a plurality of elements may be disposed to secure element stability.

The converter 410 may be connected to an output terminal, but the DC power may also be input directly. For example, DC power from a solar cell may be input directly to the smoothing capacitor C or may be input after DC-to-DC conversion. Because the DC power is stored across the smoothing capacitor C, two terminals of the smoothing capacitor C may also be referred to as DC terminals or DC link terminals.

The DC terminal voltage detector B may detect a DC terminal voltage Vdc at both terminals of the smoothing capacitor C. To this end, the DC terminal voltage detector B may include a resistance element, an amplifier, and the like. The detected DC terminal voltage Vdc may be input to the inverter controller 430 as a discrete signal in a form of a pulse.

The inverter 420 may include a plurality of inverter switching elements, and may convert the smoothed DC power Vdc into three-phase AC power va, vb, and vc of a predetermined frequency by an on/off operation of the switching elements and output the same to the driver 32. In the inverter 420, each of upper-arm switching elements Sa, Sb, and Sc and each of lower-arm switching elements S′a, S′b, and S′c are connected in series with each other, and a total of three pairs of upper and lower-arm switching elements may be connected in parallel with each other (Sa&S′a, Sb&S′b, and Sc&S′c).

A diode is connected in anti-parallel to each switching element Sa, S′a, Sb, S′b, Sc, and S′c.

The switching elements in the inverter 420 perform the on/off operation based on an inverter switching control signal Sic from the inverter controller 430. Accordingly, three-phase AC power having a predetermined frequency is output to the driver 32.

The inverter controller 430 may control the switching operation of the inverter 420. To this end, the inverter controller 430 may receive an output current io detected by the output current detector E.

The inverter controller 430 outputs the inverter switching control signal Sic to the inverter 420 to control the switching operation of the inverter 420. The inverter switching control signal Sic, as a switching control signal in a pulse width modulation (PWM) scheme, is generated and output based on the output current value io detected by the output current detector E.

The controller C may sense a state inside the drum by sensing the output current value io detected by the current detector 220. In addition, the controller C may sense the state inside the drum based on the location signal H sensed by the location sensor 235. For example, while the drum 3 rotates, the amount of laundry, a dehydration rate, a moisture content, and the like may be sensed based on the output current value io of the driver 32. In addition, the controller C may sense eccentricity of the drum 4, that is, unbalance UB of the drum 3. Such eccentricity sensing may be performed based on a ripple component of the current io detected by the current detector 220 or a change in the rotation speed of the drum 4.

In addition, the controller C may sense the state inside the drum by sensing the input current value is input to the inverter controller. A process and a calculation method for sensing the state inside the drum via the current value will be described later.

The output current detector E may detect the output current io flowing between the inverter 420 and the three-phase driver 32. The output current detector E detects the current flowing through the driver 32. The output current detector E may detect all output currents ia, ib, and ic of respective phases, and may also detect the output currents of two phases using three-phase balance.

The output current detector E may be located between the inverter 420 and the driver 32, and a current transformer (CT), a shunt resistor, and the like may be used for the current detection. When the shunt resistor is used, three shunt resistors may be located between the inverter 420 and the driver 32, or respective terminals thereof may be respectively connected to the three lower-arm switching elements S′a, S′b, and S′c of the inverter 420.

In one example, using the three-phase balance, two shunt resistors may also be used. In addition, when one shunt resistor is used, the corresponding shunt resistor may be disposed between the capacitor C described above and the inverter 420.

The detected output current io, as a discrete signal in a form of a pulse, may be applied to the inverter controller 430, and the inverter switching control signal Sic is generated based on the detected output current io. Hereinafter, a description will be made assuming that the detected output current io corresponds to the three-phase output currents ia, ib, and ic.

In one example, the three-phase driver 32 has a stator and a rotor, and three-phase AC voltage with a specific frequency is applied to coils of respective phases a, b, and c of the stator, causing the rotor to rotate.

Such driver 32 may include a surface-mounted permanent-magnet synchronous motor (SMPMSM), an interior permanent magnet synchronous motor (IPMSM), a synchronous reluctance motor (Synrm), and the like. Among them, the SMPMSM and the IPMSM are permanent magnet synchronous motors (PMSM), and the Synrm does not have a permanent magnet.

In one example, the inverter controller 430 may control the switching operation of the switching element in the converter 410 when the converter 410 includes the switching element. To this end, the inverter controller 430 may receive the input current is detected by the input current detector A. Further, the inverter controller 430 may output a converter switching control signal Scc to the converter 410 to control the switching operation of the converter 410. Such converter switching control signal Scc, as a switching control signal in a pulse width modulation (PWM) scheme, may be generated and output based on the input current is detected from the input current detector A.

In one example, the location sensor 235 may sense a rotor location of the driver 32. To this end, the location sensor 235 may include a hall sensor. The sensed rotor location His input to the inverter controller 430 and used as basis for speed calculation and the like.

(c) in FIG. 11 shows an embodiment of a specific circuit structure in which the inverter controller 430 controls the driver 32. The inverter controller 430 may include an axis converter 510, a speed calculator 520, a current command generator 530, a voltage command generator 540, an axis converter 550, and a switching control signal output unit 560.

The axis converter 510 may receive the three-phase output currents ia, ib, and ic detected by the output current detector E and converts them into two-phase currents iα and iβ of a stationary coordinate system. The axis converter 510 may convert the two-phase currents iα and iβ of the stationary coordinate system into two-phase currents id and iq of a rotating coordinate system.

The speed calculator 520 may calculate the speed based on the location signal H of the rotor input from the location sensor 235. That is, the speed may be calculated by dividing the location signal by time. The speed calculator 520 may output the calculated location and the calculated speed based on the input location signal H of the rotor.

The current command generator 530 generates a current command value i*q based on a calculated speed w and a speed command value ω*r. For example, in the current command generator 530, a P1 controller 535 may perform P1 control based on a difference between the calculated speed w and the speed command value ω*r, and generate a current command value iq. In the drawing, a q-axis current command value i*q is exemplified as the current command value, but unlike the drawing, a d-axis current command value i*d may also be generated together. In one example, a value of the d-axis current command value i*d may be set to 0.

In one example, the current command generator 530 may further include a limiter (not shown) that limits a level of the current command value i*q so as not exceed an allowable range. Next, the voltage command generator 540 generates d-axis and q-axis voltage command values v*d and v*q, based on d-axis and q-axis currents id and iq axis-converted into a two-phase rotating coordinate system by the axis converter, and current command values i*d and i*q in the current command generator 530 or the like. For example, the voltage command generator 540 may perform the P1 control in the P1 controller 544 and generate the q-axis voltage command value v*q based on a difference between the q-axis current iq and the q-axis current command value i*q. In addition, the voltage command generator 540 may perform the P1 control in the P1 controller 548 and generate the d-axis voltage command value v*d, based on a difference between the d-axis current id and the d-axis current command value i*d. In one example, a value of the d-axis voltage command value v*d may be set to 0 in response to the case in which the value of the d-axis current command value i*d is set to 0.

In one example, the voltage command generator 540 may further include a limiter (not shown) that limits a level of the d-axis and q-axis voltage command values v*d and v*q so as not to exceed an allowable range.

In one example, the generated d-axis and q-axis voltage command values (v*d and v*q are input to the axis converter 550.

The axis converter 550 receives a location Q calculated by the speed calculator 520 and the d-axis and q-axis voltage command values v*d and v*q, and performs axis conversion. First, the axis converter 550 performs conversion from the two-phase rotating coordinate system to the two-phase stationary coordinate system. In this regard, the location Q calculated by the speed calculator 520 may be used.

Then, the axis converter 550 performs conversion from the two-phase stationary coordinate system to a three-phase stationary coordinate system. Via such conversion, the axis converter 1050 outputs three-phase output voltage command values v*a, v*b, and v*c.

The switching control signal output unit 560 generates and outputs the inverter switching control signal Sic based on the pulse width modulation (PWM) scheme based on the three-phase output voltage command values v*a, v*b, and v*c.

The output inverter switching control signal Sic may be converted into a gate operating signal by a gate driver (not shown) and may be input to a gate of each switching element in the inverter 420. As a result, each of the switching elements Sa, S′a, Sb, S′b, Sc, and S′c in the inverter 420 performs the switching operation.

In one example, the switching control signal output unit 560 may generate and output the inverter switching control signal Sic that mixes a two-phase pulse width modulation scheme and a three-phase pulse width modulation scheme in relation to the embodiment of the present disclosure.

For example, in an accelerated rotation period to be described below, the inverter switching control signal Sic in the three-phase pulse width modulation scheme may be generated and output, and in a constant-speed rotation period, the inverter switching control signal Sic in the two-phase pulse width modulation scheme may be generated and output to detect a counter electromotive force.

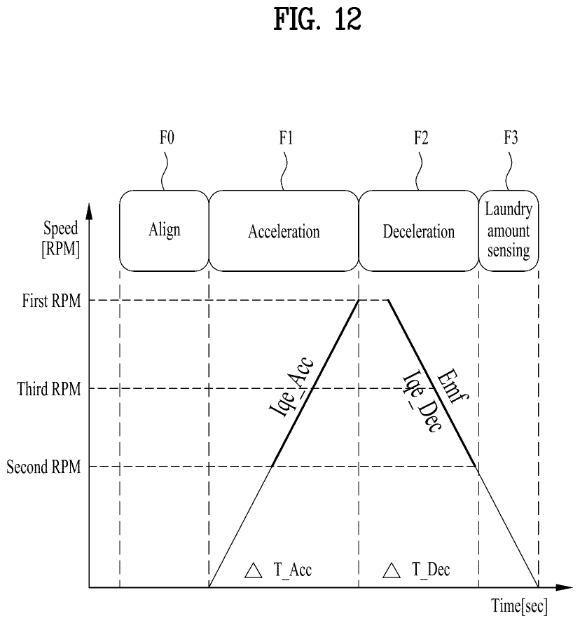

FIG. 12 shows an embodiment in which the controller C senses an amount of laundry via acceleration and deceleration of a drum.

The laundry treating apparatus of the present disclosure may perform a sensing step F of sensing the amount of laundry inside the drum 3 before performing the washing cycle, before performing the rinsing cycle, and before performing the dehydration cycle.

To this end, the controller C may perform an acceleration step F1 of accelerating the drum 3, a deceleration step F2 of decelerating the drum 3, and a laundry amount sensing step F3 of sensing the amount of laundry accommodated in the drum via an acceleration measurement value of the driver 32 during the acceleration step and a deceleration measurement value of the driver during the deceleration step.

The laundry treating apparatus of the present disclosure senses the acceleration measurement value measured by or applied to the driver 32 while accelerating the driver 32, and senses the deceleration measurement value measured by or applied to the driver 32 while decelerating the driver 32. Thereafter, the acceleration measurement value and the deceleration measurement value are calculated to sense the amount of laundry accommodated in the drum 3.

The acceleration measurement value and the deceleration measurement value may be command values applied to the driver 32 while operating the driver 32, or may be measurement values measured by the driver 32 while operating the driver 32.

For example, the command value may be a current command value or a voltage command value derived from the P1 controller 535 applied to operate the driver 32, and the measurement value may be a current value or a voltage value of the driver 32 itself measured by the location sensor 235 or the current sensor 225.

Therefore, the laundry treating apparatus of the present disclosure may significantly shorten a time required to sense the amount of laundry by omitting a step of maintaining operation of the driver 32 at a constant speed.

In addition, the laundry treating apparatus of the present disclosure may save not only the process of maintaining the driver 32 at the constant speed, but also energy and time required to maintain the constant speed. In addition, the laundry treating apparatus of the present disclosure may completely ignore a frictional force of the driver 32 itself that should be overcome when maintaining the driver 32 at the constant speed in the calculation process.

When the controller C senses the amount of laundry and uses the command value, the controller C does not need to feed back an actual situation to the driver 32 or consider an actual operating situation of the driver 32. Therefore, it may become simple and easy for the controller C to calculate the laundry amount value. In addition, because a calculation formula for calculating the amount of laundry becomes simple, the laundry amount value may be obtained quickly.

Specifically, the acceleration measurement value may include an acceleration current value Iq_Acc measured by the driver 32, and the deceleration measurement value may include a deceleration current value Iq_Dec measured by the driver 32.

The acceleration current value may include a current command value Iq*_Acc for rotating the driver 32 during the acceleration step, and the deceleration current value may include a current command value Iq*_Dec for rotating the driver 32 during the deceleration step.

In one example, when the measurement value is used while the controller C senses the amount of laundry, the actual situation is reflected as it is in the driver 32, so that the laundry amount value may be accurately obtained.

In addition, the command value occurs only when the driver 32 is operated or is actively controlled by being powered. Therefore, when the measurement value is used, there is an advantage that data for sensing the amount of laundry may be obtained even when the power to the driver 32 is cut off or the driver 32 is not actively controlled.

The laundry treating apparatus of the present disclosure may decelerate the driver 32 in a dynamic braking scheme or the like by cutting off the power in the deceleration step F2. Therefore, an algorithm for controlling the deceleration step F2 may be omitted, and energy for the deceleration step F2 may be saved.

Furthermore, because the power is cut off in the deceleration step F2, the voltage command value may be O. Therefore, in the present disclosure, the amount of laundry may be sensed via calculation only with the current, excluding the voltage.

That is, the method for controlling the laundry treating apparatus of the present disclosure may ignore or not use the voltage command value or the voltage value itself, and only use the current value, so that the calculation formula for sensing the amount of laundry may be very simple. Because the calculation formula is simple, the calculation may be performed quickly and accurately, so that the amount of laundry may be sensed accurately.

Specifically, data and algorithms (hereinafter, calculation formulas) for calculating the acceleration measurement value and the deceleration measurement value may be stored in the controller C. The calculation formula may not use the voltage value from the beginning. Accordingly, because there is no need to calculate the counter electromotive force, in the present disclosure, the constant-speed rotation step of the driver 32 may be omitted.

For example, the calculation formula of the present disclosure may be provided as follows.

A laundry amount value of the present disclosure (inertia, Jm, Load_data)

$$= \frac{3}{2} \frac{P}{2} {K}_{e} \frac{{i}_{q}^{Acc} - {i}_{q}^{Dec}}{Δ {ω}_{m}^{Acc} / Δ {t}_{Acc} - Δ {ω}_{m}^{Dec} / Δ {t}_{Dec}}$$

may be calculated using a following formula. The P and Ke are constant values of the driver 32 itself, which may be measured by the controller C, and a denominator corresponds to a difference between a speed change amount in the acceleration step and a speed change amount in the deceleration step.

The speed change amount may be measured by the controller C because of the location sensor 235, calculated by measuring a time until the acceleration or the deceleration is performed, or immediately sensed by measuring the current or the like.

Therefore, in the present disclosure, the amount of laundry may be immediately calculated by only measuring an acceleration output current value Iq_Acc when accelerating and a deceleration output current value Iq_Dec when decelerating. That is, the acceleration current value may be considered to include the acceleration output current value Iq_Acc output from the driver during the acceleration step, and the deceleration current value may be considered to include the deceleration output current value Iq_Dec output from the driver during the deceleration step.

In addition, an average value Iqe_Acc of the current values measured by the driver during the acceleration step may be applied to the acceleration output current value, and an average value Iqe_Dec of the current values measured by the driver during the deceleration step may be applied to the deceleration output current value.

In either case, the amount of laundry may be calculated with only one factor, the current value, and a factor of the voltage value may be omitted, so that the laundry amount calculation may become simplified and calculation speed and accuracy of the amount of laundry may be improved.

Therefore, even when a duration of the acceleration step is very short or a duration of the acceleration step is very short, the amount of laundry may be accurately sensed, so that a time required for the laundry amount sensing itself may be further reduced.

In one example, the laundry treating apparatus of the present disclosure measures the amount of laundry by performing the deceleration immediately after the acceleration. Therefore, the time required for measuring the amount of laundry itself is very short, and the laundry inside the drum 3 is not able to move during the time. Therefore, because the amount of laundry may be sensed in a short period of time while the state of the laundry does not change, the accuracy of the laundry amount calculation may be further increased.

In one example, the calculation formula applied to the laundry amount sensing in the present disclosure uses the difference between the current value in the acceleration step and the current value in the deceleration step. Therefore, a frictional force of the driver in the acceleration step and a frictional force of the driver in the deceleration step become equal to each other, so that current compensation formulas considering the frictional forces cancel each other. Therefore, the laundry amount sensing control method of the laundry treating apparatus of the present disclosure does not need to consider the frictional force of the driver 32, so that a process of compensating for or tuning the frictional force may be omitted. In addition, because the laundry amount sensing in the present disclosure does not use the voltage value, a process of compensating for or tuning an error of the voltage value may be omitted, and because the constant speed process is omitted, a process of compensating for or tuning the movement of the laundry and the frictional force of the driver 32 may be omitted. As a result, the laundry amount sensing control method of the laundry treating apparatus of the present disclosure may sense the amount of laundry very quickly and accurately because the amount of laundry is derived immediately when the current value is input, and there is no procedure for compensating for or tuning the amount of laundry.

Therefore, an amount of load on the controller C may be reduced, the controller C may be replaced with a relatively simple configuration, or a performance of the controller C may be utilized in other ways.

In one example, as may be seen from the calculation formula, the acceleration measurement value may further include the speed change amount of the acceleration step F1, and the deceleration measurement value may further include the speed change amount of the deceleration step F2.

The speed change amount of the acceleration step F1 and the speed change amount of the deceleration step F2 are only necessary to obtain a difference between inertia of the acceleration step F1 and inertia of the deceleration step F2. Separate measurement of the voltage value or the like may not be necessary, and furthermore, compensation or tuning processes may not be necessary.

To illustrate the above in more detail, the above calculation formula is derived by a following calculation formula.

$$acceleration inertia = \frac{{T}_{e}^{A C C}}{{D}_{m}^{A c c} - {D}_{m}^{D e c}} deceleration inertia = \frac{{T}_{e}^{D e c}}{{D}_{m}^{A c c} - {D}_{m}^{D e c}} where$$

$${D}_{m} = \frac{d {ω}_{m}}{d t} = \frac{{Δω}_{m}}{Δ t}$$

In this regard, because the amount of laundry is calculated via the difference between the acceleration inertia and the deceleration inertia, the change in the speed is required.

Therefore, when the acceleration measurement value and the deceleration measurement value are measured in the same RPM period of the drum, ranges of the speed change are equal to each other, so that the calculation may become simpler. That is, it is desirable that the acceleration step F1 and the deceleration step F2 share the same speed band.

In one example, the method for controlling the laundry treating apparatus of the present disclosure senses the amount of laundry by performing the acceleration step F1 and the deceleration step F2 and using the current command value or the current value measured by the driver 32.

In this regard, because the calculation formula uses the current value, the deceleration step F2 may be performed first, and then the acceleration step Bb may be performed to measure the current value and sense the amount of laundry via the same calculation formula.

In one example, the sensing step F3 may perform a preparatory step F0 of checking the location of the driver 32 to set a reference value for performing the acceleration step F1 and the deceleration step F2. In the preparation step F0, the drum 4 may be in a stationary state.

The acceleration step F1 may additionally accelerate the drum, which is stationary in the preparation step F0, to a first rpm, and the deceleration step F2 may decelerate the drum from the first rpm. That is, the acceleration step F1 and the deceleration step F2 may be performed continuously. Because the deceleration step F2 simply involves lowering the current command value toward the driver 32 in the acceleration step F1 or cutting off the voltage applied to the driver 32, there is no concern about damage to the controller C or the circuit.

In this regard, the acceleration measurement value and the deceleration measurement value may be measured in a range between the first rpm and a second rpm lower than the first rpm. That is, the amount of the laundry may be sensed by measuring the current value in a period band including a vertex in the speed graph. This has an advantage of minimizing situations where errors may occur because the amount of laundry is sensed by measuring the current value in a continuous situation.

In one example, the acceleration measurement value and the deceleration measurement value may be measured in a range between the second rpm lower than the first rpm and a third rpm higher than the second rpm and lower than the first rpm. That is, the amount of laundry may be sensed by measuring the current value in the same speed period band, although it is not a period including the vertex. This has an advantage of improving the accuracy of the laundry amount calculation by measuring the stabilized current value because the speed change is the greatest at the vertex.

In one example, the first rpm may be set to a lower rpm than a fixing rpm at which the laundry accommodated inside the drum 3 is attached to the inner wall of the drum 3. That is, the first rpm may be relatively lower than an rpm applied in the washing, rinsing, and dehydration cycles.

In this case, the process of the controller C directly calculating the moment of inertia or the process of extracting the moment of inertia by comparing the moment of inertia with the laundry amount data stored in the storage S may be omitted.

A current amount applied in the acceleration step F1 may be defined as a first current amount, and a current amount applied in the deceleration step F2 may be defined as a second current amount. The controller C may sense the amount of laundry via the first current amount and the second current amount.

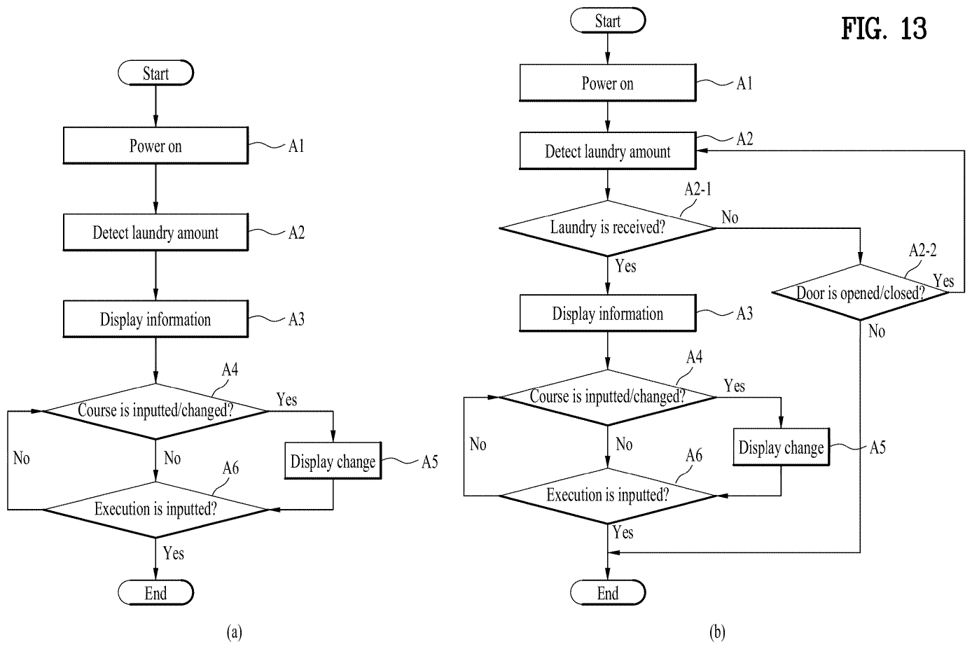

FIG. 13 shows an embodiment of a laundry treating apparatus of the present disclosure utilizing a laundry amount sensing scheme based on the aforementioned structure and scheme.

(a) in FIG. 13 shows an embodiment basically using the laundry amount sensing scheme described above.

When the power unit 710 of the laundry treating apparatus of the present disclosure is pressed, the power may be supplied to the water supply 23, the driver 32, the drainage 25, and the like, and the power may also be supplied to the controller C.

The controller P may be set to sense the amount of laundry when the power unit 710 is pressed and the power is supplied.

That is, the laundry treating apparatus of the present disclosure may have the pressing of the power unit 710 as a prerequisite for sensing the amount of laundry.

Therefore, even when the user opens the door 14 before pressing the power unit 710, puts the laundry into the drum 3, and closes the door 14, the controller C may immediately sense the amount of laundry.

The controller P may calculate an expected time required for performing a specific course or option based on the amount of laundry.

To this end, the controller P may recognize the expected time corresponding to the amount of laundry.

In addition, the controller P may organize an amount of detergent required when performing the arbitrary course or option based on the amount of laundry as data. The controller C may calculate the amount of detergent required when performing washing of the laundry with the course or option.

For example, the laundry treating apparatus of the present disclosure may perform the power supply step A1 of supplying the power by pressing the power unit 710 of the laundry treating apparatus, and the laundry amount sensing step A2 of sensing the amount of laundry accommodated in the drum 3 when the power supply step A1 is performed.

In other words, the laundry treating apparatus of the present disclosure may sense the amount of laundry before the execution unit 740 is pressed, rather than sensing the amount of laundry after the execution unit 740 is pressed.

When the amount of laundry is sensed in the laundry amount sensing step A2, an information display step A3 of displaying at least one of the amount of laundry, the expected execution time of the course or the option for washing the laundry, and the amount of detergent required for the course or the option on the display 800 may be performed.

In the information display step A3, an execution time corresponding to a preset standard course or standard option corresponding to the amount of laundry may be displayed.

The user may identify the amount of laundry and the execution time of the preset course or option displayed in the information display step A3, compare those with schedule thereof, and identify the amount of detergent.

In other words, the laundry treating apparatus of the present disclosure may identify information related to the amount of laundry before the execution unit 740 is pressed, select desired course and option, and press the execution unit 740. That is, when the user is satisfied with the information displayed in the information display step A3, the user may press the execution unit 740. The controller C may perform an execution input step A6 of sensing that the execution unit 740 is pressed.

When the execution input step A6 is performed, the controller C may control the lock to lock the door 14 to the cabinet 10 to prevent the door 14 from being opened arbitrarily.

When the execution input step A6 is performed, the controller C may perform one or more of the washing cycle, the rinsing cycle, and the dehydration cycle based on settings of the course or the option.

However, after the user identifies at least one of the amount of laundry, the execution time of the preset course or option, and the amount of detergent in the information display step A3, a course setting step A4 of selecting the course and the option via the course selector 720 and the option selector 730 may be further performed.

That is, the user may select the arbitrary course or option, not the standard course that is performed by default.

For example, the user may identify the amount of laundry via the course setting step A4, and then press one or more of the course selector 720 and the option selector 730, and may identify the execution time in association with the amount of laundry, and then press one or more of the course selector 720 and the option selector 730 to change the course or the option.

When the course setting step A4 is performed, the controller C may perform a change display step A5 of recalculating the expected execution time or the amount of detergent of the changed course or option corresponding to the amount of laundry and transmitting the same to the display P8.

In the change display step A5, one or more of the expected execution time and the changed detergent amount of the changed course or option may be displayed on the display P8.

When determining that the expected execution time or the detergent amount is appropriate, the user may press the execution unit 740, and when the expected execution time or the detergent amount is not appropriate, the user may re-press at least one of the course selector 720 and the option selector 730.

The controller C may perform the execution input step A6 of sensing the pressing of the execution unit 740.

However, when the re-pressing of one or more of the course selector 720 and the option selector 730 is sensed, the course setting step A4 and the change display step A5 may be performed again.

As a result, the laundry treating apparatus of the present disclosure may complete the laundry amount sensing before the user selects and performs final course and option. Furthermore, by calculating the amount of laundry within 3 seconds by rotating the drum less than once, the information on the laundry amount may be provided before one or more of the course selector 720 and the option selector 730 are pressed.

For example, at a time point when the power unit 710 is pressed and the display 800 is booted, the laundry amount sensing may be already completed, and the information corresponding to the laundry amount may be provided to the user.

Therefore, while identifying the information on the laundry amount, the user may identify the expected time or the like of the course and the option most suitable at the current time point and set the optimal course and option, or inject the optimal amount of detergent.

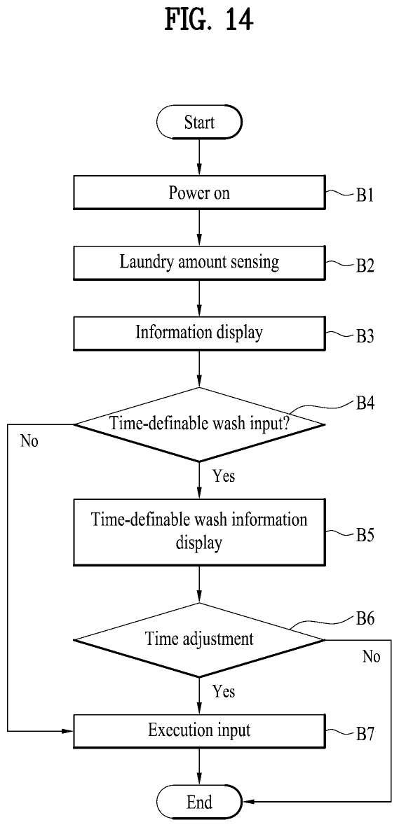

(b) in FIG. 13 shows an extended embodiment of the control method in (a) in FIG. 14.

The laundry treating apparatus of the present disclosure may perform a power input step A1 of supplying the power to one or more of the controller C, the driver 32, the water supply 23, the drainage 25, and the control panel 16 when a command from the power unit P46 is input.

When the power input step A1 is performed, the laundry treating apparatus may perform the laundry amount sensing step A2 of sensing the amount of laundry.

A scheme of sensing the amount of laundry in the laundry amount sensing step A2 is a scheme of rotating the drum less than once as described above.

In this regard, the controller C may also perform a laundry sensing step A2-1 of sensing whether the laundry is accommodated in the drum 3. When there is the laundry in the drum 3 in the laundry sensing step A2-1, the control method in (a) in FIG. 13 may be performed.

However, when the laundry is not accommodated in the drum 3, the controller C may perform a door opening/closing sensing step A2-2 of waiting until the door 132 opens and closes.

That is, when not sensing the amount of laundry, the controller C may wait until the opening/closing of the door is sensed.

In this regard, when the door opening/closing sensing step A2-2 is performed, the controller C may perform the laundry amount sensing step A2 again to additionally sense the amount of laundry.

Accordingly, the laundry treating apparatus of the present disclosure may immediately sense the amount of laundry when the laundry is accommodated in the drum 3 before the power unit 710 is pressed. However, when the laundry is not accommodated in the drum 3 before the power unit 710 is pressed, the amount of laundry may be sensed by waiting for the laundry to be put into the drum 3.

In other words, the laundry treating apparatus of the present disclosure may, in principle, perform the laundry amount sensing immediately when the power unit 710 is pressed and the power is supplied to the controller C.

Therefore, when the user first puts the laundry into the drum 3 before pressing the power unit 710 and then presses the power unit P46, the controller C may perform the laundry amount sensing.

However, when there is no laundry inside the drum 3 before the power unit 710 is pressed, the controller C may perform the laundry amount sensing by waiting for the door to open or close. In one example, whether there is the laundry may be sensed in the laundry amount sensing scheme. In this regard, when there is no sensed laundry amount, the laundry amount may not be displayed on the display 800.

In one example, when the opening/closing of the door 14 is sensed after the power unit 710 is pressed, the controller C may determine that the laundry has been input and perform the laundry amount sensing. In one example, when there is no sensed laundry amount, the laundry amount may not be displayed or information that there is no laundry inside may be displayed on the display 800.

When there is the sensed laundry amount, the laundry treating apparatus of the present disclosure may display at least one of the weight information of the laundry, the execution time of the course and the option corresponding to the laundry amount, and the required amount of detergent on the display 800.

As a result, the laundry treating apparatus of the present disclosure may sense the laundry amount before the execution unit 740 is pressed, and transmit the information such as the execution time of the course or the option and the required amount of detergent to the user.

FIG. 14 shows a control method for adjusting an execution time of a time-definable washing course.

When the power unit 710 of the laundry treating apparatus of the present disclosure is pressed, the power may be supplied to the water supply 70, the driver 32, the drainage 80, and the like, and the power may also be supplied to the controller P.

The controller P may be set to sense the amount of laundry when the power unit 710 is pressed and the power is supplied.

That is, the laundry treating apparatus of the present disclosure may have a prerequisite for sensing the amount of laundry as the pressing of the power unit 710.

Therefore, even when the user opens the door 14, puts the laundry into the drum 3, and closes the door 14 before pressing the power unit 710, the controller P may immediately sense the amount of laundry.

Alternatively, although not shown in the drawing, the controller P may sense the amount of laundry before the execution unit 740 is pressed when sensing the opening and closing of the door 14. That is, a condition for sensing the amount of laundry may be the opening and closing of the door 14.

The controller P may calculate an expected time for performing a specific course or option based on the amount of laundry.

To this end, the controller P may recognize the expected time corresponding to the amount of laundry in the storage P2.

In addition, the storage P2 may organize an amount of detergent required when performing the arbitrary course or option based on the amount of laundry as data. The controller P

may calculate the amount of detergent required when performing washing of the laundry with the course or option.

For example, the laundry treating apparatus of the present disclosure may perform a power supply step B1 of supplying the power by pressing the power unit 710 of the laundry treating apparatus, and a laundry amount sensing step B2 of sensing the amount of laundry accommodated in the drum 3 when the power supply step B1 is performed.

When the amount of laundry is sensed in the laundry amount sensing step B2, an information display step B3 of displaying, on the display 800, at least one of the amount of laundry, an expected execution time of the course or the option for performing the washing of the laundry, and the amount of detergent required for the course or the option may be performed.

In the information display step B3, an execution time of a preset standard course or standard option corresponding to the amount of laundry may be displayed.

The user may identify the amount of laundry and the execution time of the preset course or option displayed in the information display step B3 to compare them with schedules thereof and identify the amount of detergent.

After the information display step B3, the user may input a time-definable washing course, which is a course in which the user is able to specify the execution time of the course or the option, via the course selector 720. The controller P may perform a time-definable washing input step B4 of receiving input of the time-definable washing course.

The user may input the time-definable washing course via the course selector 720, or may input the time-definable washing course via a separate physical button that may input the time-definable washing course. That is, the course selector 720 may include the separate physical button that may input the time-definable washing course.

For example, the user may select the download course unit 720e via the course selector 720 to perform the time-definable washing course.

When the time-definable washing course is input in the time-definable washing input step B4, a time-definable washing information display step B5 of displaying an initial execution time of the time-definable washing course on the display 800 may be performed.

The controller P may calculate the initial execution time of the time-definable washing course based on the amount of laundry sensed in the laundry amount sensing step B2.

To this end, the controller P may recognize the initial execution time of the time-definable washing course corresponding to the amount of laundry in the storage P2.

In addition, the initial execution time of the time-definable washing course corresponding to the amount of laundry may be organized as data in the storage P2.

The initial execution time of the time-definable washing course may be set to an optimal time that may secure a washing performance corresponding to the amount of laundry at a minimum.

For example, when a weight of the laundry is in a range of 0 to 4 kg, the initial execution time of the time-definable washing course may be set to 30 minutes, when the weight of the laundry is in a range of 4 to 7 kg, the initial execution time of the time-definable washing course may be set to 60 minutes, when the weight of the laundry is in a range of 7 to 15 kg, the initial execution time of the time-definable washing course may be set to 100 minutes, when the weight of the laundry is in a range of 15 to 19 kg, the initial execution time of the time-definable washing course may be set to 105 minutes, and when the weight of the laundry is equal to or greater than 19 kg, the initial execution time of the time-definable washing course may be set to 115 minutes.

The initial execution time of the time-definable washing course may be displayed on a time display 821 of the display 800.

When the user is not satisfied with the initial execution time of the time-definable washing course in the time-definable washing information display step B5, the execution time of the time-definable washing course may be changed via at least one of the course selector 720 and the option selector 730. The controller P may perform a time adjustment step B6 of changing the execution time of the time-definable washing course via at least one of the course selector 720 and the option selector 730.

The time adjustment step B6 may be performed after the time-definable washing input step B4 or the time-definable washing information display step B5.

In the time adjustment step B6, at least one of the course selector 720 and the option selector 730 may be switched to receive a command for adjusting the execution time of the time-definable washing course.

That is, at least one of the course selector 720 and the option selector 730, which was not originally equipped to adjust the execution time, may be switched so as to adjust the execution time of the time-definable washing course.

When the course selector 720 is rotatably disposed on the cabinet 1, the execution time of the time-definable washing course may be changed by rotating the course selector 720. For example, when the course selector 720 is rotated to the left, the execution time of the time-definable washing course may decrease, and when the course selector 720 is rotated to the right, the execution time of the time-definable washing course may increase.

Accordingly, when the course selector 720 is rotatably disposed on the cabinet 1, the user may easily increase or decrease the execution time of the time-definable washing course by rotating the course selector 720.

In one example, in the time adjustment step B6, a changeable range of the execution time of the time-definable washing course may vary depending on the amount of laundry sensed in the laundry amount sensing step B2.

In the time adjustment step B6, a changeable minimum time for the execution time of the time-definable washing course may be set to a minimum time for securing the washing performance based on the sensed amount of laundry, and a changeable maximum time for the execution time of the time-definable washing course may be set to a time considering a temperature, an RPM, and the like.

A changeable range of the execution time may become narrower as the amount of laundry increases. For example, when the weight of the laundry is in the range of 0 to 4 kg, the execution time may be changed in 9 levels, and when the weight of the laundry is in the range of 15 to 19 kg, the execution time may be changed in 6 levels.

When the course selector 720 or the option selector 730 is equipped as a physical button, there may be difficulty in adjusting the time because a separate button for increasing or decreasing the execution time of the time-definable washing course is not equipped.

Therefore, the laundry treating apparatus 100 may be separately equipped with the button for adjusting the execution time of the time-definable washing course or may switch the existing button to be able to adjust the time.

To this end, the option selector 730 may include a first option selector 730a that selects one of options for setting conditions including an intensity and a number of times excluding the time adjustment of the course, and a second option selector 730b that receives an input for selecting an option different from that of the first option selector 730a.

The first option selector 730a may receive a command to select one among arbitrary options that may be selected by the option selector 730, and the second option selector 730b may receive a command to select one among the remaining options excluding the option that may be selected by the first option selector 730a.

In the time adjustment step B6, the first option selector 730a may be switched to increase the execution time of the time-definable washing course when being pressed, and the second option selector 730b may be switched to decrease the execution time of the time-definable washing course when being pressed.

The first option selector 730a and the second option selector 730b may be buttons disposed in parallel with each other.

For example, the first option selector 730a may be equipped as a reservation manager, and when the reservation manager is pressed, the execution time of the time-definable washing course may be increased, and the second option selector 730b may be equipped as a tub sterilization unit, and when the tub sterilization unit is pressed, the execution time of the time-definable washing course may be decreased.

In one example, the user needs to know that at least one of the components of the option selector 730 has been switched to adjust the execution time of the time-definable washing course in the time adjustment step B6.

To this end, the option selector 730 may be equipped as a separate physical button, and may further include a lamp that is disposed next to text describing an option content and that is turned on in response to the option selector 730. Accordingly, which button of the option selector 730 has been switched to adjust the time may be intuitively indicated, and a user's input may be induced.

Specifically, when the time-definable washing course is input in the time-definable washing input step B4, the lamp disposed in the button that has been switched to adjust the execution time is turned on. The user may change the execution time of the time-definable washing course by pressing the option selector 730 corresponding to the lit lamp.

For example, when the time-definable washing course is input in the time-definable washing input step B4, the lamps disposed in the reservation manager and the tub sterilization unit may be turned on, and the user may increase or decrease the execution time of the time-definable washing course in sequential steps by pressing the reservation manager 7397 or the tub sterilization unit 7398 in the time adjustment step B6.

Therefore, even when the course selector 720 or the option selector 730 is equipped as the physical button, the user may increase or decrease the execution time of the time-definable washing course in the sequential steps, thereby maximizing convenience.

As a result, the user may select the laundry treating execution time within a time range that may achieve an optimal performance based on the amount of laundry, in accordance with the schedule thereof.

In addition, the display 800 may display the execution time of the time-definable washing course changed in the time adjustment step B6. Specifically, when the user changes the execution time of the time-definable washing course via the course selector 720 or the option selector 730, the changed execution time is displayed on the display 800.

When the user is satisfied with the initial execution time displayed in the time-definable washing information display step B5 and does not need to adjust the time, the user may not change the execution time in the time adjustment step B6.

When the user does not adjust the execution time in the time adjustment step B6 or is satisfied with the changed execution time, the execution unit 740 may be pressed. The controller P may perform an execution input step B7 of sensing that the execution unit 740 is pressed.

Alternatively, even when the time-definable washing course is not pressed in the time-definable washing input step B4, after the user identifies at least one of the amount of laundry, the execution time of the preset course or option, and the amount of detergent in the information display step B3, a course setting step (not shown) of receiving the pressing of the course selector 720 or the option selector 730 may be further performed.

For example, the user may identify the amount of laundry via the course setting step (not shown) and then press the course selector 720 or the option selector 730, and may identify the execution time and then press the course selector 720 or the option selector 730 to change the course or the option.

After the course or the option is selected in the course setting step (not shown), the execution input step B7 may be performed.

When the execution input step B6 is performed, the controller P may control the lock to lock the door 14 to the cabinet 1 to prevent the door 14 from being opened arbitrarily.

In addition, when the execution input step B7 is performed, the controller P may perform one or more of the washing cycle, the rinsing cycle, and the dehydration cycle based on settings of the course or the option. After the execution input step B7, the procedure of sensing the amount of laundry may be omitted. Therefore, an increase of an overall washing time may be prevented.

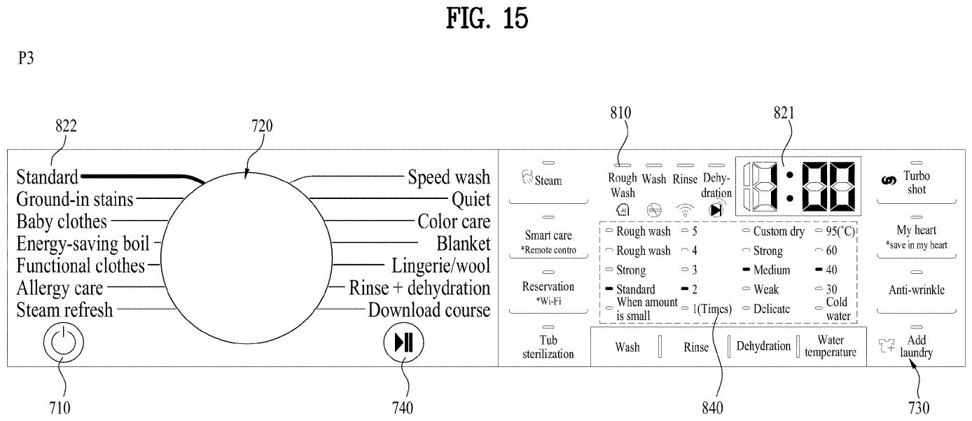

FIGS. 15 to 18 sequentially show manipulation processes of a control panel P3 of a laundry treating apparatus of the present disclosure when adjusting an execution time of a time-definable washing course.

Referring to FIG. 15, the user may press the power unit 710, and the controller P of the laundry treating apparatus may automatically sense the amount of laundry. In this regard, the standard course may be automatically selected.

The time display 821 may display the execution time of the standard course based on the sensed amount of laundry. For example, when the amount of laundry sensed in the laundry amount sensing step B2 is in the range of 4 to 7 kg, the execution time of the standard course, 60 minutes, may be displayed on the time display 821 in the information display step B3.

In addition, portions corresponding to options of the standard course of the option display

840 may be lit. For example, portions corresponding to “standard”, “rinse 2 times”, “dehydration in progress”, and “water temperature 40° C.” may be lit.

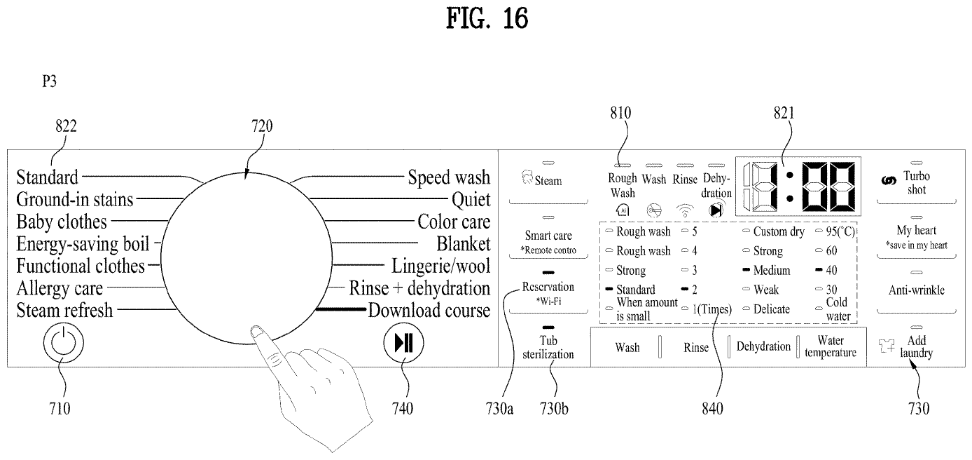

Next, referring to FIG. 16, the user may select a “download course” by manipulating the course selector 720. The user may perform the time-definable washing course by selecting the “download course”.

When the user selects the “download course” and the time-definable washing course is input in the time-definable washing input step B4, a lamp disposed corresponding to the “download course” in the course display 822 may be turned on to indicate to the user that the “download course” has been selected.

In addition, when the user selects the “download course” and the time-definable washing course is input in the time-definable washing input step B4, the time-definable washing information display step B5 of displaying the initial execution time of the time-definable washing course on the time display 821 may be performed. For example, when the amount of laundry sensed in the laundry amount sensing step B2 is in the range of 4 to 7 kg, 60 minutes may be displayed on the time display 821.

In addition, portions corresponding to options of the initial time-definable washing course of the option display 840 may be lit. For example, portions corresponding to “standard”, “rinse 2 times”, “dehydration in progress”, and “water temperature 40° C.” may be lit.

In addition, the lamps corresponding to the first option selector 730a and the second option selector 730b, which are switched such that the user may change the execution time, may be lit in the time adjustment step B6. Thus, the user may intuitively recognize which button has been switched to change the execution time.

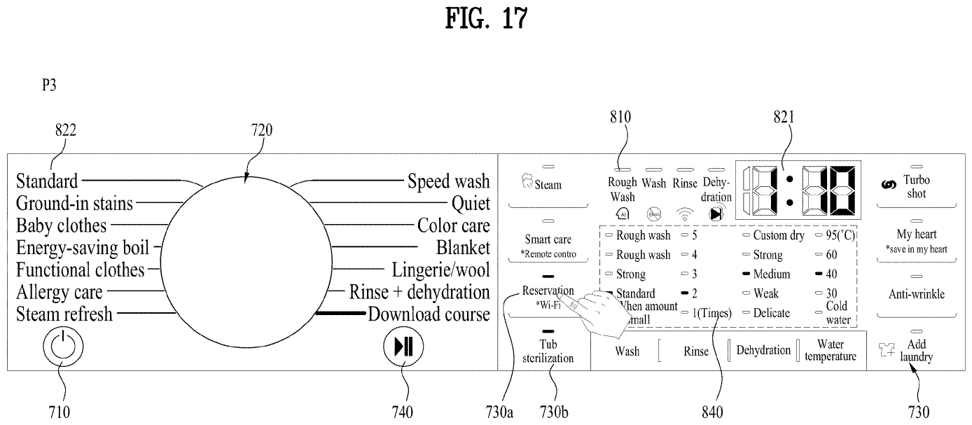

Referring to FIG. 17, when the user selects the first option selector 730a in the time adjustment step B6, the execution time of the time-definable washing course may be increased. The first option selector 730a may be equipped as the reservation manager. Depending on the number of times the first option selector 730a is pressed, the execution time may increase in the sequential steps based on a change range set based on the amount or laundry.

In addition, the increased execution time of the time-definable washing course may be displayed on the time display 821.

For example, when the amount of laundry sensed in the laundry amount sensing step B2 is in the range of 4 to 7 kg, 1 hour and 10 minutes may be displayed on the time display 821 when the first option selector 730a is pressed once in the time adjustment step B6.

In addition, portions corresponding to options of the time-definable washing course with the increased execution time of the option display 840 may be lit. For example, portions corresponding to “standard”, “rinse 3 times”, “dehydration in progress”, and “water temperature 40° C.” may be lit.

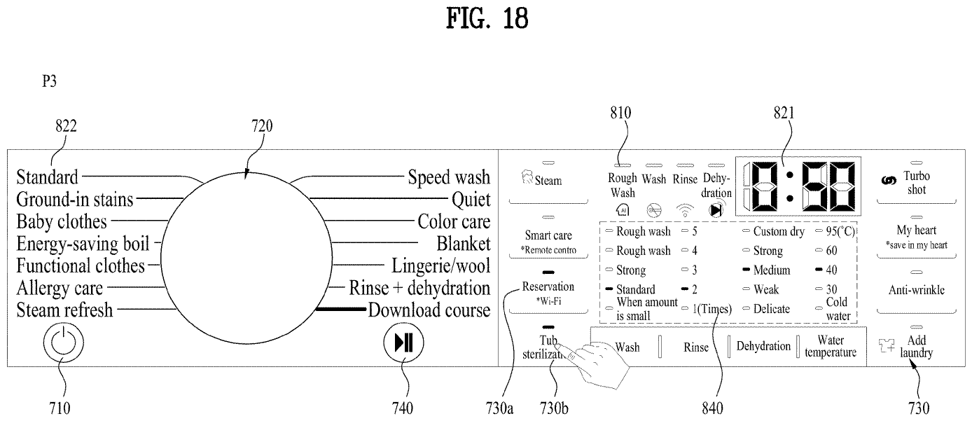

Conversely, referring to FIG. 18, when the user selects the second option selector 730b in the time adjustment step B6, the execution time of the time-definable washing course may decrease. The second option selector 730b may be equipped as the tub sterilization unit.

Depending on the number of times the second option selector 730b is pressed, the execution time may decrease in the sequential steps based on a change range set based on the amount of laundry.

In addition, the decreased execution time of the time-definable washing course may be displayed on the time display 821.

For example, when the amount of laundry sensed in the laundry amount sensing step B2 is in the range of 4 to 7 kg, 50 minutes may be displayed on the time display 821 when the second option selector 730b is pressed once in the time adjustment step B6.

In addition, portions corresponding to options of the time-definable washing course with the reduced execution time of the option display 840 may be lit. For example, portions corresponding to “standard”, “rinse once”, “dehydration in progress”, and “water temperature 40° C.” may be lit.

Accordingly, the user may intuitively recognize that the execution time and the option of the time-definable washing course change each time the first option selector 730a or the second option selector 730b is pressed, via the execution time displayed on the time display 821 and the option displayed on the option display 840.

What is claimed is:

1. A method for controlling a laundry treating apparatus including a drum configured to accommodate laundry therein, a driver configured to rotate the drum, a course selector configured to receive an input of selecting one of arbitrary courses for removing foreign substances from the laundry by rotating the driver, and a plurality of option selectors configured to receive an input of selecting one of arbitrary options for setting or changing a condition for performing the course, the method comprising:
a time-definable washing input step of receiving input of a time-definable washing course that is a course where a user is able to specify an execution time of the course or the option via the course selector; and
a time adjustment step of changing an execution time of the time-definable washing course,
wherein the time adjustment step includes switching at least one of the course selector and the option selector to receive a command for adjusting the execution time of the time-definable washing course when the time-definable washing input step is performed.

2. The method of claim 1, wherein the option selector includes:
a first option selector configured to select one of options for setting conditions including an intensity and a number of times of the course; and
a second option selector configured to receive an input for selecting an option different from the option of the first option selector,
wherein the time adjustment step includes switching the first option selector to receive a command for increasing the execution time of the time-definable washing course when the first option selector is pressed, and switching the second option selector to receive a command for decreasing the execution time of the time-definable washing course when the second option selector is pressed.

3. The method of claim 2, wherein the first option selector is equipped as a reservation manager configured to determine an operating time of the laundry treating apparatus in advance,
wherein the second option selector is equipped as another component of the option selector disposed parallel to the reservation manager.

4. The method of claim 1, wherein the option selector is equipped as a separately pressable physical button.

5. The method of claim 4, wherein the laundry treating apparatus further includes a plurality of lamps configured to illuminate corresponding to the option selector so as to induce pressing of the option selector,
wherein the time adjustment step includes illuminating at least one of the plurality of lamps so as to induce the pressing of the option selector that has been switched to receive the command for adjusting the execution time of the time-definable washing course.

6. The method of claim 5, wherein the time adjustment step includes illuminating two of the plurality of lamps.

7. The method of claim 5, wherein the option selector includes a first option selector configured to select one of options for setting conditions including an intensity and a number of times of the course, and a second option selector configured to receive an input for selecting an option different from the option of the first option selector,
wherein the time adjustment step includes switching the first option selector to receive a command for increasing the execution time of the time-definable washing course when the first option selector is pressed, and switching the second option selector to receive a command for decreasing the execution time of the time-definable washing course when the second option selector is pressed,
wherein among the plurality of lamps, a lamp corresponding to the first option selector and a lamp corresponding to the second option selector are illuminated.

8. The method of claim 1, wherein the laundry treating apparatus further includes a display configured to display information of the course or the option,
wherein the method further includes a time-definable washing information display step of displaying an initial execution time of the time-definable washing course on the display when the time-definable washing input step is performed.

9. The method of claim 8, further comprising a laundry amount sensing step of sensing an amount of laundry by rotating the drum,
wherein the initial execution time of the time-definable washing course varies depending on the amount of laundry sensed in the laundry amount sensing step.

10. The method of claim 1, wherein the laundry treating apparatus further includes a display configured to display information of the course or the option,
wherein the time adjustment step includes displaying the changed execution time of the time-definable washing course on the display.

11. The method of claim 10, wherein the display includes a content display configured to display the execution time of the course or the option,
wherein an initial execution time or the execution time changed in the time adjustment step of the time-definable washing course is displayed on the content display.

12. The method of claim 1, wherein the course selector includes a separate physical button for inputting the time-definable washing course.
